(19) United States
(12) Patent Application Publication
(10) Pub. No.: US 2017/0131872 A1
(43) Pub. Date: May 11, 2017

(54) Mobile User Interface

(71) Applicant: Google Inc., Mountain View, CA (US)

(72) Inventor: Ali Adil Husain, Mountain View, CA (US)

(21) Appl. No.: 14/935,258

(22) Filed: Nov. 6, 2015

(51) Int. Cl. G06F 3/0484; G06F 3/0482

(52) U.S. Cl. CPC G06F 3/04842; G06F 3/0482

(57) ABSTRACT

A method for efficiently presenting and allowing rapid navigation of data on a computing device may include generating at the computing device a graphical user interface including a static layout, the static layout including a display region and a first level interaction region for a first level, the display region configured to display data representing one of a second level subgroup and a third level item, and the first level interaction region having a plurality of sub-regions; receiving a user input; determining whether the received user input is a selection of one of the plurality of sub-regions of the first level interaction region; in response to the determination that the received user input is the selection of one of the plurality of sub-regions, updating the display region to include the second level subgroup corresponding to the selection of the one of the plurality of sub-regions; determining whether the received user input is a selection of the display region; and in response to the determination that the user input is the selection of the display region, updating the display region to include the third level item corresponding to the second level subgroup. The present disclosure may also include corresponding systems, apparatus, and computer programs to perform the actions of the above method.

### BACKGROUND

The present disclosure relates to computer generated user interfaces. More specifically, the present disclosure relates to a method and system for efficiently organizing, presenting, and providing interaction with data having a plurality of hierarchical levels. Still more particularly, some implementations relate to a user interface for providing news on mobile devices.

Computer applications are sometimes used to present data, particularly data that can be organized hierarchically, for example, into a plurality of levels or data trees. Hierarchical data may include news articles sorted into categories, news events, and specific articles. For example, frequently, a news source will present a large quantity of textual and graphical information in a list or outline format including a list of categories and news articles in those categories. These existing solutions for presenting hierarchical data (e.g., news articles) require significant computational resources and internet bandwidth to download and navigate the hierarchical data, which can overtax client devices having limited bandwidth and processing capabilities.

### SUMMARY

The present disclosure relates to systems and methods for efficiently organizing, presenting, and providing interaction with data having a plurality of levels. The techniques described herein may include a method that includes providing display regions on a graphical user interface that may be both statically located and dynamically updated with various levels of hierarchical data according to user inputs on particular regions of the graphical user interface. Similarly, the methods may allow ease of access and navigation of hierarchical data as well as rapid retrieval and display of the hierarchical data through the strategic placement of graphical user interface elements.

In general, according to one innovative aspect of the subject matter described in this disclosure may be implemented in a system that includes a processor and a memory storing instructions that, when executed by the processor, cause the system to generate a graphical user interface including a static layout, the static layout including a display region and an interaction region for a first level, the display region configured to display data representing one of a second-level subgroup and a third-level item, and the first-level interaction region having a plurality of sub-regions; receive a user input; determine whether the received user input is a selection of one of the plurality of sub-regions of the first-level interaction region; in response to the determination that the received user input is the selection of one of the plurality of sub-regions, update the display region to include the second-level subgroup corresponding to the selection of the one of the plurality of sub-regions; determine whether the received user input is a selection of the display region; and in response to the determination that the user input is the selection of the display region, update the display region to include the third-level item corresponding to the second-level subgroup.

In general, another innovative aspect of the subject matter described in this disclosure may be embodied in methods that include generating at the computing device a graphical user interface including a static layout, the static layout including a display region and an interaction region at a first level, the display region configured to display data representing one of a second-level subgroup and a third-level item, and the first-level interaction region having a plurality of sub-regions; receiving a user input; determining whether the received user input is a selection of one of the plurality of sub-regions of the first-level interaction region; in response to the determination that the received user input is the selection of one of the plurality of sub-regions, updating the display region to include the second-level subgroup corresponding to the selection of the one of the plurality of sub-regions; determining whether the received user input is a selection of the display region; and in response to the determination that the user input is the selection of the display region, updating the display region to include the third-level item corresponding to the second-level subgroup.

These and other implementations may each optionally include one or more of the following features. For example, features may include: retrieving a set of data from a data server, the set of data including a first-level group, a second-level subgroup, and third-level items, the third-level items being articles, the second level-subgroup being a cluster of articles related to a common event, and the first-level group being a group of clusters of articles related to a common category; wherein determining whether the received user input is selection of one of the plurality of sub-region includes determining whether the user input includes a scrubbing input across the first-level interaction region; wherein the display region includes an information area and a selection area, the information area displaying textual information and the selection area displaying an image corresponding to the textual information; wherein the selection area is located proximate to a vertical side of the graphical user interface; wherein the graphical user interface includes a plurality of display regions and wherein updating the display region to include the third-level item includes updating each of the plurality of display regions with different data. Additional features may include: determining a ranking for the third-level item within the second-level subgroup based on a metadata tag associated with the third-level item; determining whether there is an image associated with the third-level item; and selecting the third-level item for display in the graphic user interface if a rank of the third-level item satisfies a threshold. Still other features include the display region having a selection area located proximate to a first vertical edge of the graphical user interface and an information area, and wherein the method further comprises determining whether the user input included a horizontal swipe beginning at the selection area and ending at the information area and in response to a horizontal swipe updating the display region to move the selection area to be located proximate to a second vertical edge of the graphical user interface.

Other implementations of one or more of these aspects include corresponding systems, apparatus, and computer programs, configured to perform the actions of the methods, encoded on computer storage devices.

These implementations are particularly advantageous in a number of respects. For instance, the implementations and combination of elements and techniques described herein are particularly beneficial as they allow rapid navigation and consumption of a significant quantity of information especially on a small sized display; reduce required computational resources; and reduce the data communication bandwidth required to retrieve the hierarchical data from a data server. The implementations are also advantageous because they provide a user interface that adapts to the amount of information that need to be presented, provides the data for easy hierarchy level traversal and allows high level scrubbing to transition easily between high level topics. For example, the techniques described herein allow a computing device to efficiently present an otherwise difficult to consume and navigate quantity of data from many categories and sources.

It should be understood, however, that the above features and advantages are not all-inclusive and many additional features and advantages are contemplated and fall within the scope of the present disclosure. Moreover, it should be understood that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a flowchart of an example method for efficiently organizing, presenting, and providing interaction with hierarchical data.

FIG. 2 is a flowchart of an example method for updating display regions in response to receiving a high-level interaction region scrub.

FIG. 3 is a flowchart of an example method for receiving and processing data for presentation and navigation on a client device.

FIG. 4 is a flowchart of an example method for updating display regions with low-level data in response to receiving a display region selection.

FIG. 5 is a flowchart of an example method for updating the display regions to toggle between a right and left handed layout in response to a horizontal selection area swipe.

FIGS. 6A-8B are graphic representations of example graphical user interfaces for efficiently organizing, presenting, and providing interaction with hierarchical data.

FIG. 9 is a high-level block diagram illustrating an example system for efficiently organizing, presenting, and providing interaction with hierarchical data.

FIG. 10 is a block diagram illustrating an example computing system.

### DETAILED DESCRIPTION

Systems, methods, and interfaces for efficiently organizing, presenting, and providing interaction with hierarchical data are disclosed. While the systems, methods and interfaces of the present disclosure are now described in the context of client-server system, it should be understood that the techniques described herein can be applied to systems other than a client-server system operably connected over a network. For example, a client device, third-party servers, data servers, etc., may provide some or all of the functionality described herein and may employ a cluster of servers in order to provide such functionality.

While the techniques described herein for efficiently organizing, presenting, and providing interaction with hierarchical data are presented in a number of examples, primarily in the example of news articles, it should be understood that many other types of hierarchical data are possible and contemplated. For example, hierarchical data, as defined herein, may include any data that can be organized or sorted into a plurality of levels, groups, or data trees, e.g., photographs, social network data, product information, media (movie, music, and other audio-visual) information, and so forth.

The plurality of levels of data include at least two levels of hierarchical data. For the purposes of illustration herein, a high level, a mid level, and a low level are described. A high-level group includes one or more mid-level items or subgroups. For instance, a high-level group may be a category, e.g., in the example of news articles, top, world, business, political, etc., news, which may include articles or groups of articles organized by event or topic. High-level group data may include displayable information for a high-level group, metadata for the high-level group, and/or the data for items within the high-level group. A mid-level subgroup falls within a high-level group and may also include one or more low-level items. For instance, a mid-level subgroup may be a cluster of items, e.g., in the example of news articles, groups of articles based around events, individuals, or organizations. Mid-level data may include metadata, non-displayable and/or displayable information for the mid-level subgroup, and/or the data for items within the mid-level subgroup. A low-level item falls within a mid-level subgroup and may include any type of content, e.g., an article (e.g., a news article), media (audio, video, games, etc.), social network information, photographs, products, and so forth. Low-level data (e.g., data corresponding to or representing a low-level item) may include metadata, displayable, and/or non-displayable information for the low-level item. A set of data or dataset contains some or all of the data for one or more high-level groups, mid-level subgroups, or low-level items. Although the present disclosure describes the plurality of levels in these terms, it should be understood that the techniques described herein are applicable to other implementations, quantities of levels, etc.

The techniques described herein are particularly beneficial as they allow rapid navigation and consumption of a significant quantity of information on a limited display (e.g., the screen on a computing device), reduce required computational resources (e.g., resulting in low latency), and reduce data communication bandwidth used. For example, the techniques described herein allow a computing device e.g., an inexpensive smartphone or wearable device (e.g., a smartwatch) with very limited computational resources and a very limited display size to efficiently present news from many categories and articles while using a limited quantity of data (e.g., many mobile device have slow data connections or limited cellular data plans allowing only a small amount of data to be downloaded).

Additionally, the techniques described herein also allow a user to quickly consume hierarchical data by organizing elements and interactions of a graphical user interface in such a way that a user can rapidly navigate, view, and select elements. Some implementations of the present techniques accomplish these goals particularly for a touch screen by providing a scrubbable high-level selection bar at a first edge of the display, a mid-level interaction area at a second edge of the display, and the ability to toggle which side of the display includes the mid-level interaction area.

Additionally, some implementations of the techniques described herein reduce the time required to navigate graphical elements (and specifically hierarchical data) in consideration of Fitts's Law, which states that the amount of time required for a human to select an object (e.g., on a graphical user interface) is proportional to the distance of the object from the current location of the indicator (e.g., the device used to select the object, e.g., a finger, stylus, or computer cursor) and inversely proportional to the size of the object. As such, implementations of the techniques described herein can apply Fitts's Law for navigation of hierarchical data, particularly using a small touch screen (e.g., usable in a single hand, for example, a mobile phone or wearable device), by combining the elements of a scrubbable high-level interaction region 602 located along a first edge (e.g., the bottom) of a graphical user interface and a mid-level selection region located along a selectable, second edge (e.g., a left or right side) of the graphical user interface. By combining these elements, not only can objects be selected more rapidly, but the data being displayed remains unobscured by the indicator (e.g., a finger on a touch screen). These and other implementations of the present techniques are described elsewhere throughout this description.

Some implementations of the techniques described herein also accomplish the goals of rapid navigation of hierarchical data by maintaining graphical elements in a consistent location, eschewing animation, and avoiding presentation of duplicative or surplus data. For example, some implementations include a fixed grid in which data can be displayed, which does not allow more data to be displayed or retrieved than can be displayed in the grid, such that scrolling is both not necessary and prevented. In particular, it is advantageous to prevent scrolling, because scrolling inherently changes the position of information such that the user's eyes must scan the graphical user interface to find the information. For example, when a user selects a particular high-level group, the user should automatically know where each type of information pertaining to the particular high-level group is located without having to spend time searching on the graphical user interface. Additionally, in some instances, a selected display region remains static, while other areas of the interface change to reflect the selected information. For example, when a particular mid-level subgroup is selected, low-level data corresponding to (e.g., below/within that subgroup in a data tree/hierarchy) that mid-level subgroup changes, while the data displayed for the mid-level subgroup remains unchanged on the interface. In some instances, the display regions are arranged as a fixed grid that displays data corresponding to a plurality of mid-level subgroups and that, when a particular mid-level subgroup is selected, expands the low-level data corresponding to the selected mid-level subgroup over the top of or in place of the data corresponding to the unselected mid-level subgroups. Additionally, implementations in which the data display and selection areas, as described herein, are displayed in a fixed grid allow information to be quickly read and navigated by a user, because the interface may display the same information and selections in the same graphical locations on the graphical user interface.

It should be understood that although the data presentation module 908 is described as being operable on the client device 906 to receive and organize hierarchical data, some or all of its functionality may be implemented on one or more servers, e.g., the data server 916. Similarly, although the data analysis engine 918 is described as being operable on the data server 916 to retrieve and process hierarchical data and then to transmit the hierarchical data to a data presentation module 908 on a client device 906, some or all of the functionality of the data analysis engine 918 may be operable on the client device 906 or another component of the system 900. Additionally, some or all of the functionality of the third-party application may be operable, for example, on the data server 916.

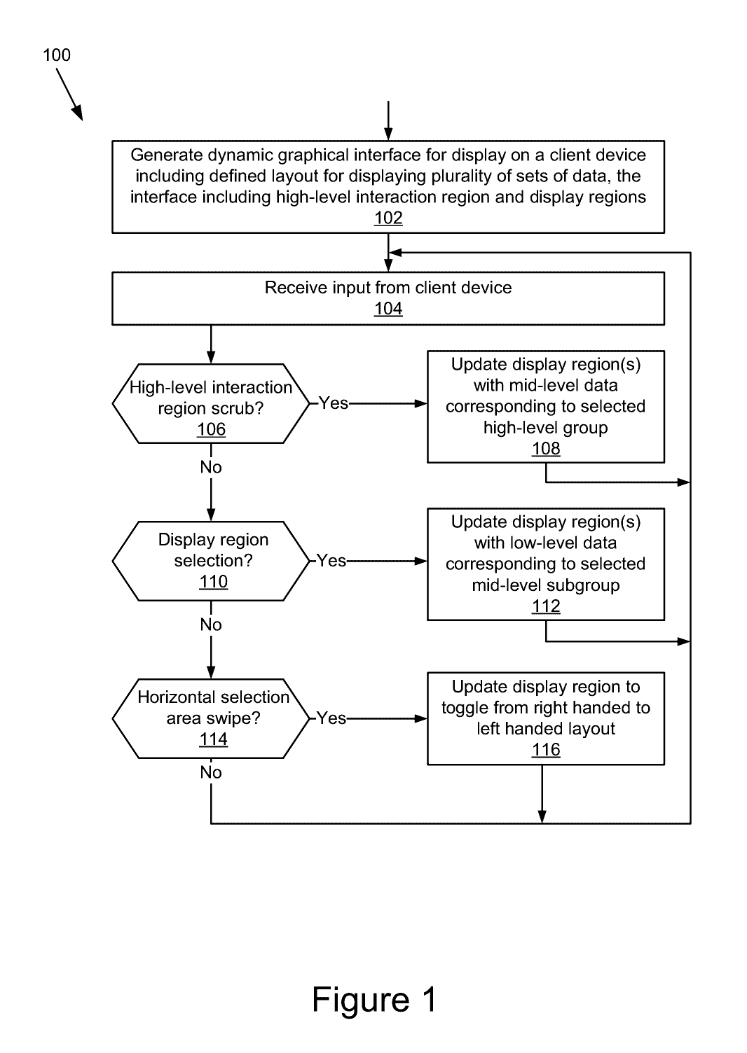

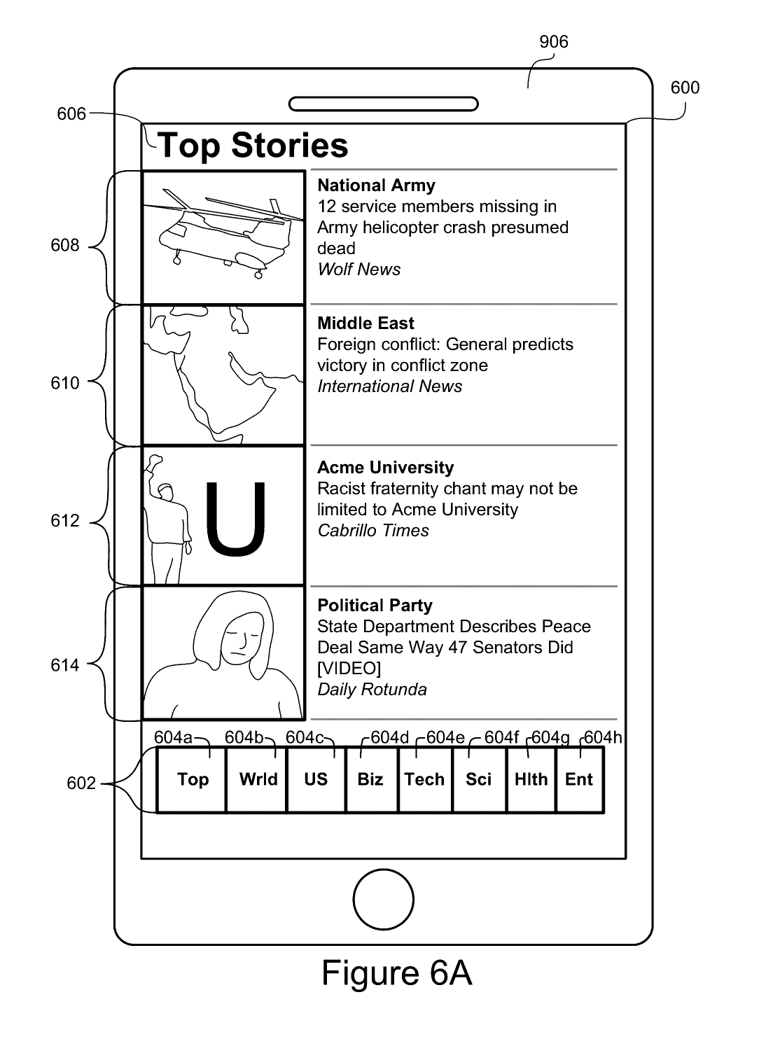

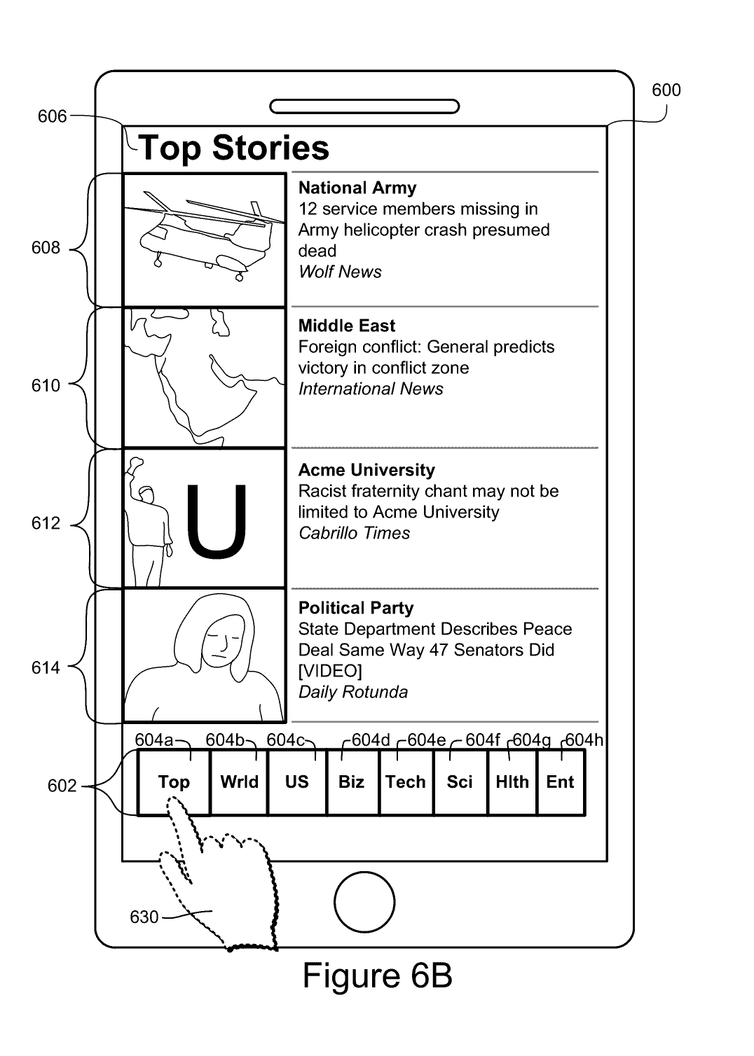

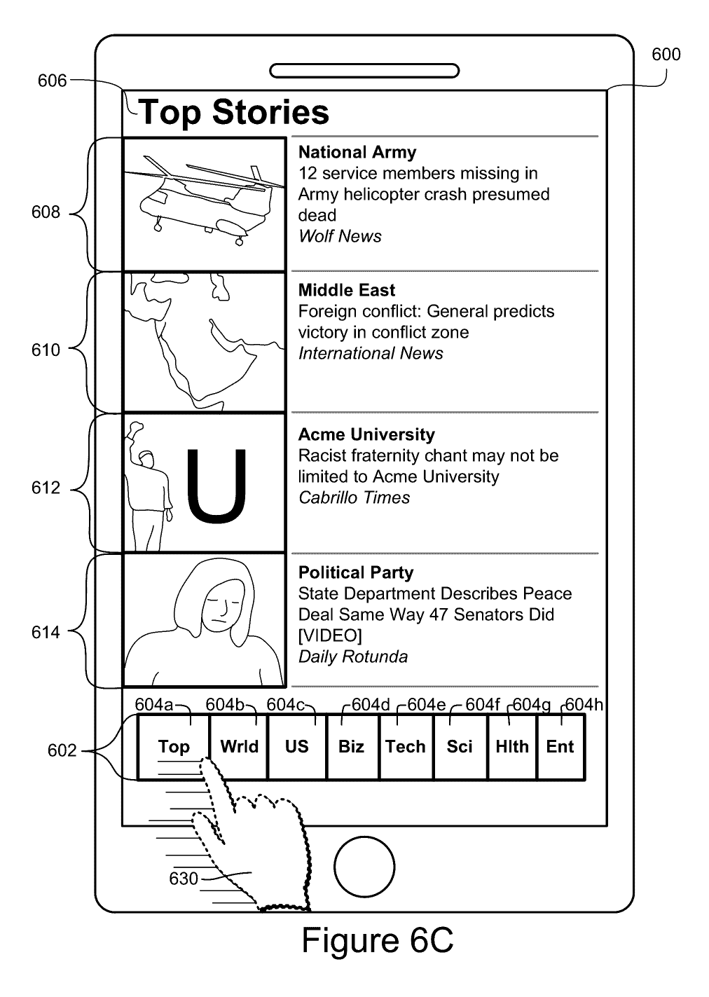

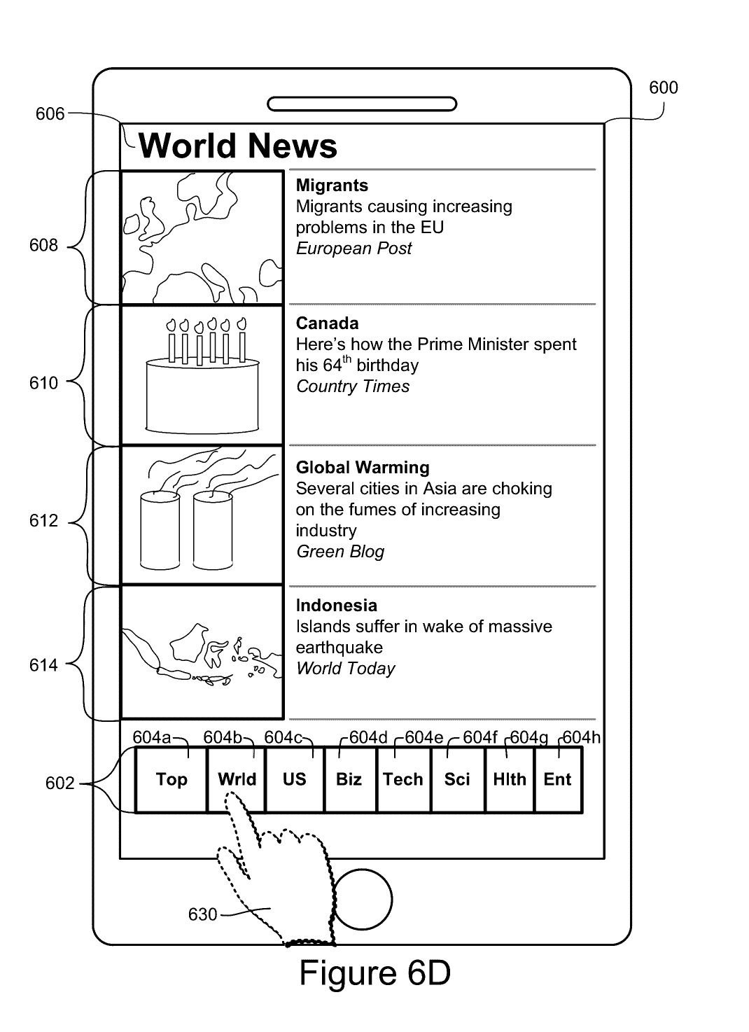

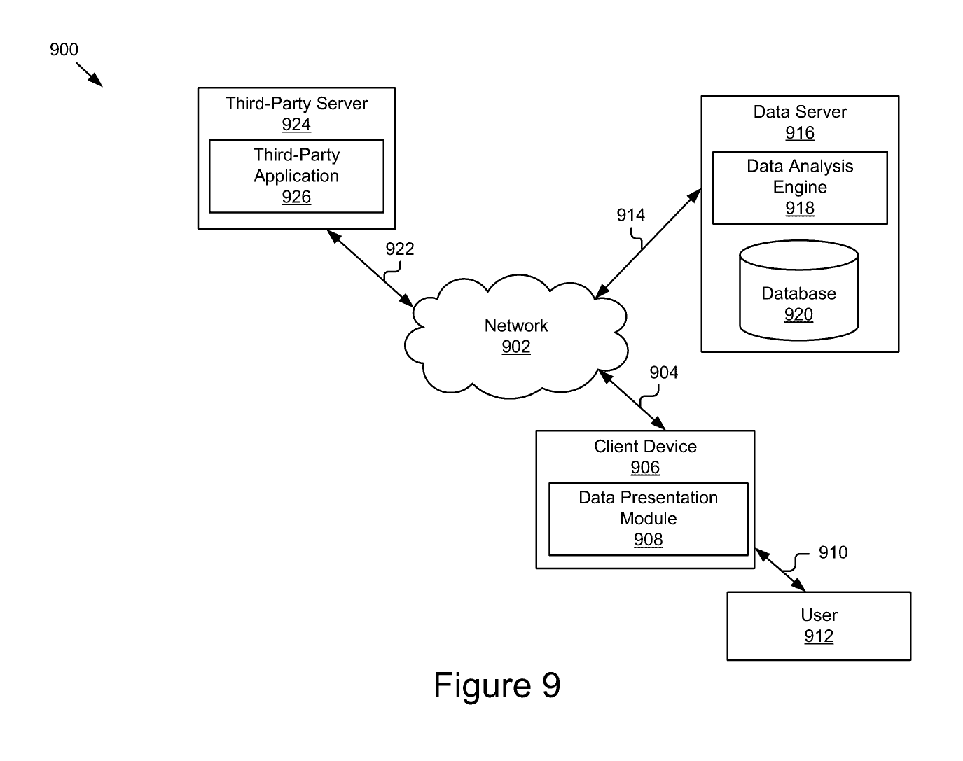

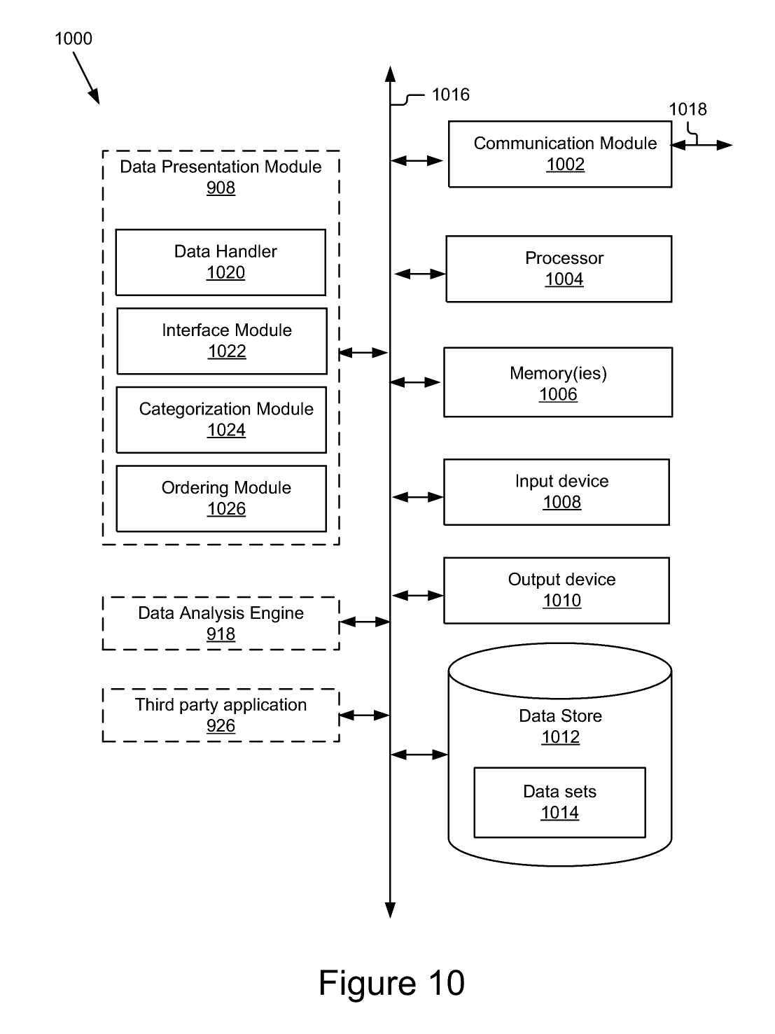

FIG. 1 is a flow chart of an example method 100 for efficiently organizing, presenting, and providing interaction with hierarchical data. At 102, the data presentation module 908 (the data presentation module 908 and its components 1020, 1022, 1024, and 1026 are shown in FIGS. 9 and 10 and described in more detail below) generates a dynamic graphical interface for display on a client device 906 including a defined layout for displaying a plurality of sets of data, the interface including a high-level interaction region 602 and display regions 608, 610, 612, and 614. The defined layout may include any number of display and/or interaction regions. In some implementations, the display and/or interaction regions remain statically located within the graphical interface and only the content within those regions is changed by the data presentation module 908. For example, the display regions 608, 610, 612, and 614 may be organized into a grid that displays selected levels of the sets of data. An example defined layout is described in reference to FIGS. 6-8B, although other configurations are possible and contemplated in the techniques described herein.

At 104, the interface module 1022 (e.g., as described below with reference to FIGS. 9 and 10) receives input from a client device 906 (e.g., via an input device 1005) and at blocks 106, 110, and 114 the interface module 1022 determines what type of input was received and what action to take in response to the user input. Once a user input is determined at 106, 110, and 114, the interface module 1022 performs the actions in 108, 112, and 116 respectively. Once the interface module 1022 fails to recognize the user input at 106, 110, or 114 and/or the actions performed at 108, 112, and 116 are completed, the method 100 may return to 104 once again to await user input. For example, after block 104, the method 100 continues to block 106.

At 106, the interface module 1022 determines whether the input was a high-level interaction region scrub. A scrub may include any moving or sliding of an indicator (e.g., a finger, stylus, cursor, or other input device) across the graphical user interface. For example, recognizing the scrubbing input and responsively updating the user interface is shown in FIGS. 6A-6D. Although the interface module 1022 may register a scrub at 106, in some implementations, it may also or alternatively register any input (e.g., a click, hover, touch on a touch screen, etc.) selecting a high-level group from a high-level interaction region 602. The scrubbable high-level interaction region 602 provides an accurate selection region that requires very little area on a graphical user interface while retaining rapid interactability. For example, a scrubbable interaction region 602 does not require a user to accurately select a small area (thus requiring additional time/effort according to Fitts's Law, as described above), so a scrubbable region can be smaller, while still allowing rapid selection of an object by tracking movement rather than solely location. An example high-level interaction region 602 is described in further detail elsewhere herein.

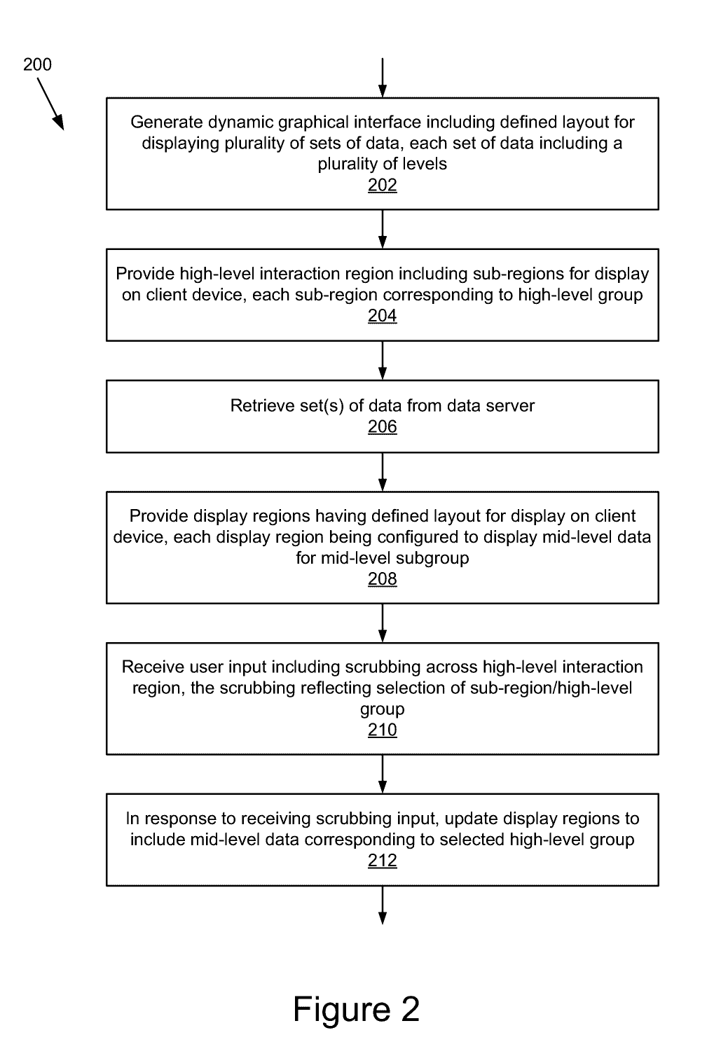

If the interface module 1022 determines 106 that the input was a high-level interaction region scrub, the method 100 continues in block 108. At block 108, the interface module 1022, in conjunction with the other components of the data presentation module 908, as described herein, updates the display region(s) with mid-level data corresponding to a selected high-level group in response to a determination at 106 that the input included a high-level interaction region scrub. The mid-level data may reflect low-level items within the mid-level subgroup. In some implementations, the mid-level data may be a summary of the low-level items within the subgroup. In some implementations, the mid-level data may include the low-level data for one of the low-level items within the subgroup. For example, in some instances, a mid-level subgroup may be a cluster of news articles describing a news event and the mid-level data for that group may be a summary of the event or, as described in further detail below, the mid-level data may include information from a selected (e.g., a designated priority article for presentation) article. Updating the display regions 608, 610, 612, and 614 in response to receiving a high-level interaction region scrub/selection at 108 is described in further detail in reference to FIG. 2.

In an example implementation of blocks 106 and 108, a user may scrub his thumb across the high-level interaction region 602 at the bottom of a touch screen (e.g., a combination of an input device 1008 and an output device 1010 as illustrated in FIGS. 6A-8B) in order to select a news category. The data presentation module 908 registers and recognizes the scrub as described herein and updates the display regions 608, 610, 612, and 614 to reflect the news category selected by the scrub by retrieving a hierarchical data set and displaying the data as described in reference to FIGS. 6A-6D herein. Each of the display regions 608, 610, 612, and 614 may include an image and text corresponding to a subgroup or cluster of articles within the selected high-level group or news category.

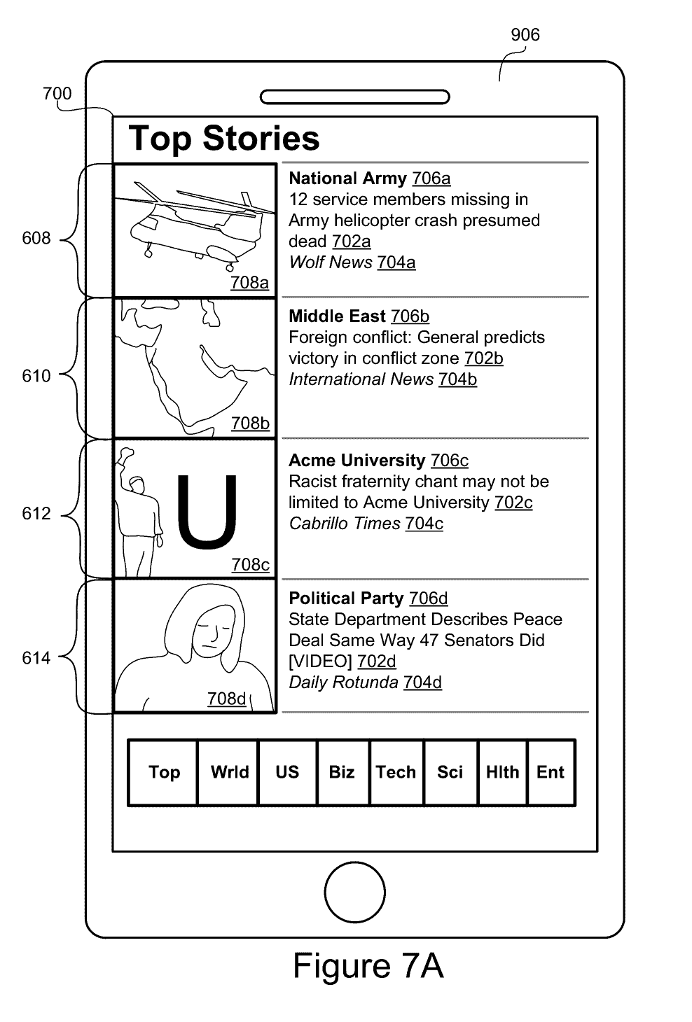

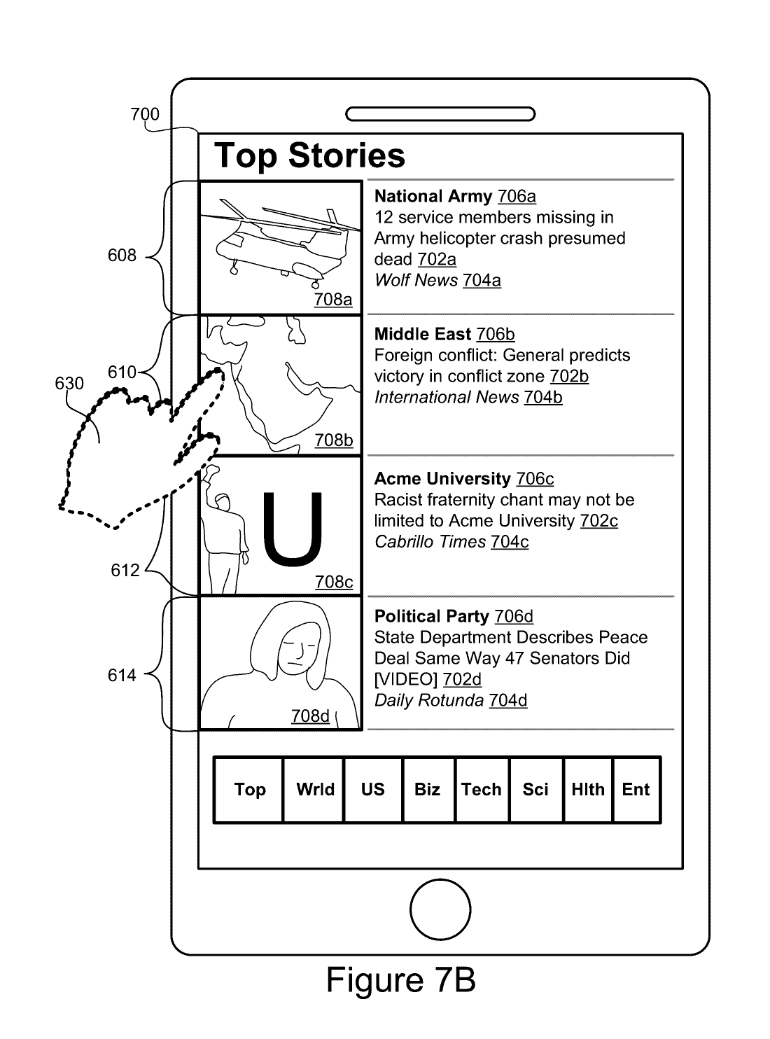

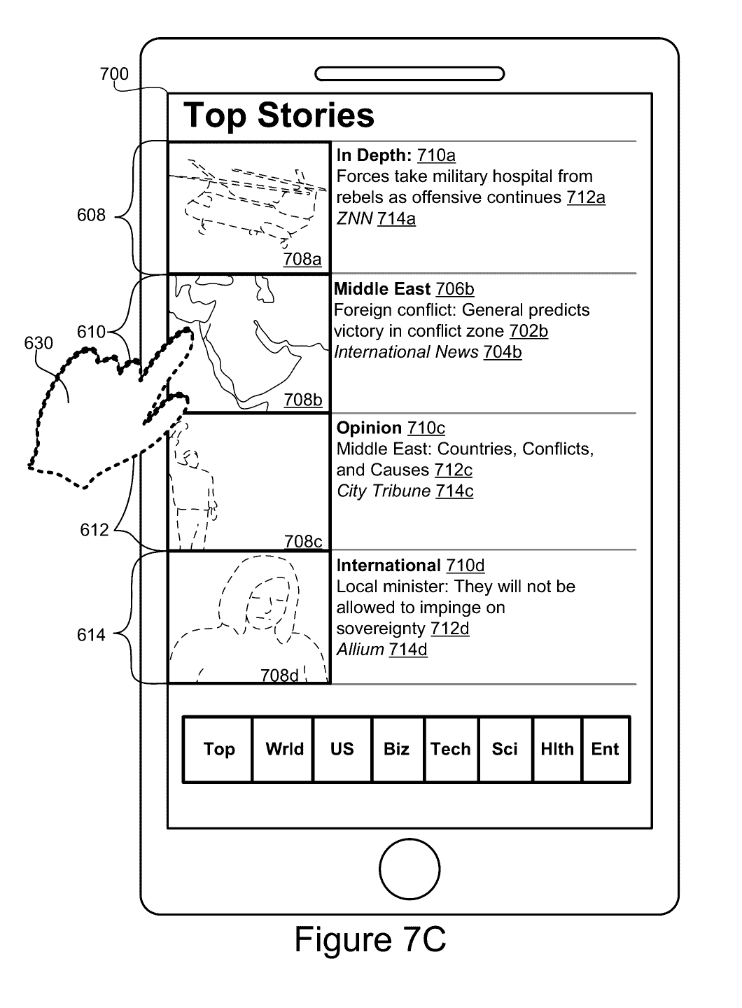

If the interface module 1022 determined that the input was not a high-level interaction region scrub in block 106, the method 100 continues to block 110. At block 110, the interface module 1022 determines whether the input received at 104 includes a display region selection. For example, recognizing the input and updating the user interface is shown in FIGS. 7A-7C. A display region (e.g., 608, 610, 612, or 614) may include an area of the graphical user interface 600, which may be divided into an information area 814 for displaying data and a selection area 816 for selecting that data. For instance, the information area 814 may display mid or low-level data and/or the selection area 816 may select a mid-level subgroup. Additionally, in cases where the display regions 608, 610, 612, and 614 are organized into a grid or series of rows, the selection areas 816 (816a-816d may be referred to simply as 814 herein) may be organized into a selection column 822 (822a and 822b may be referred to simply as 822 herein) and information areas (814a-814d may be referred to simply as 814 herein) may be organized into an information column (820a and 820b may be referred to simply as 820 herein).

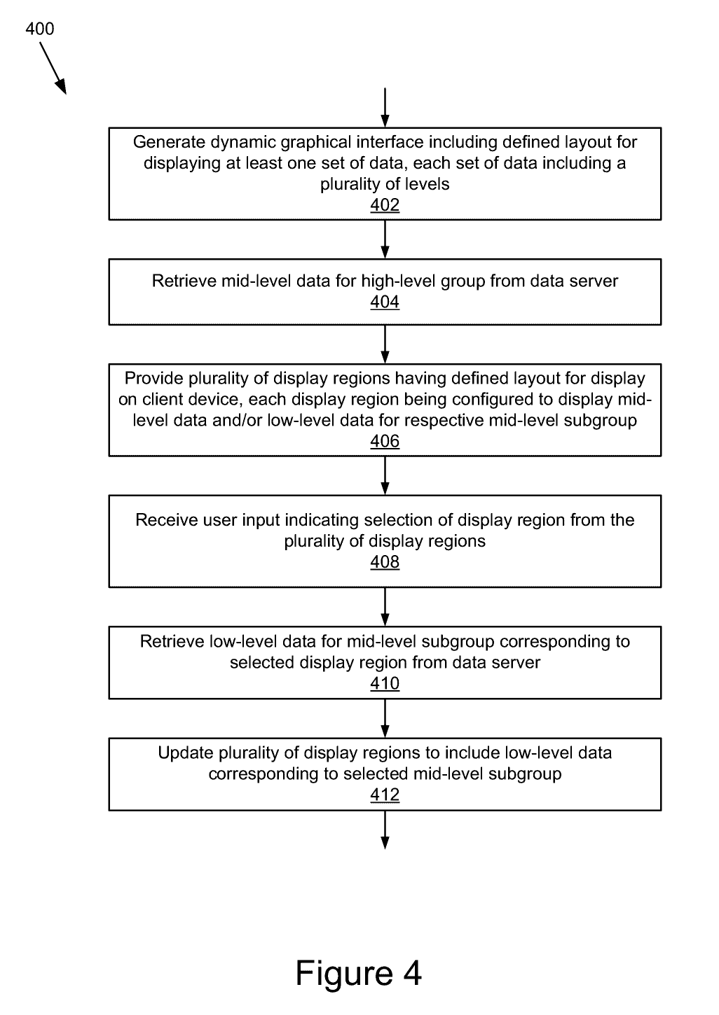

If the interface module 1022 determined 110 that the input received includes a display region selection, the method 100 proceeds to block 112. At block 112, the interface module 1022 updates the display region(s) with low-level data corresponding to the selected mid-level subgroup in response to a determination at 110 that the user input included a display region selection. For example, in some implementations, the low-level data may include information about individual articles within a cluster of news articles. Updating the display regions 608, 610, 612, and 614 with low-level data in response to receiving a display region selection is described in further detail in reference to FIG. 4.

In an example implementation of blocks 104, 110, and 112, a user may select a display region (e.g., via a specific selection area 816 on an image in a display region) with his thumb on a touch screen to select a news cluster. The data presentation module 908 registers and recognizes the display region selection as described herein and updates the display regions 608, 610, 612, and 614 to reflect the news cluster selected by the input. The display regions 608, 610, 612, and 614 may be updated to reflect a news item/article in each of the display regions 608, 610, 612, and 614. The user may then, if desired, de-select the display region/news cluster by once again selecting the display region, e.g., the user may tap on a selection area 916 a second time to return to the list of mid-level subgroups being displayed.

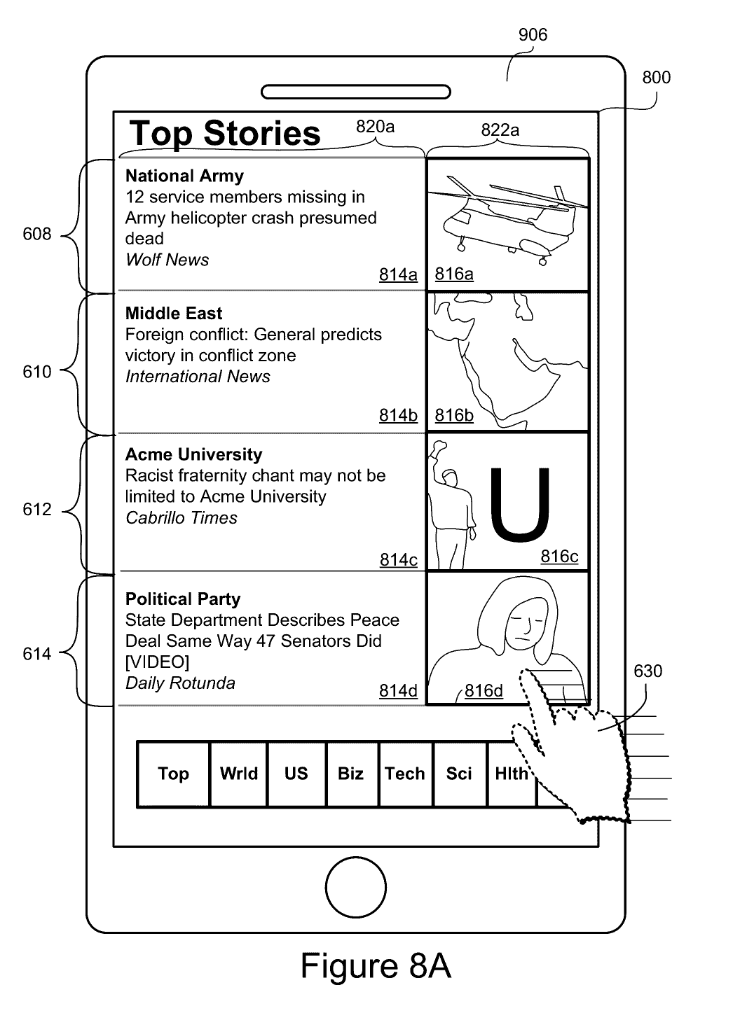

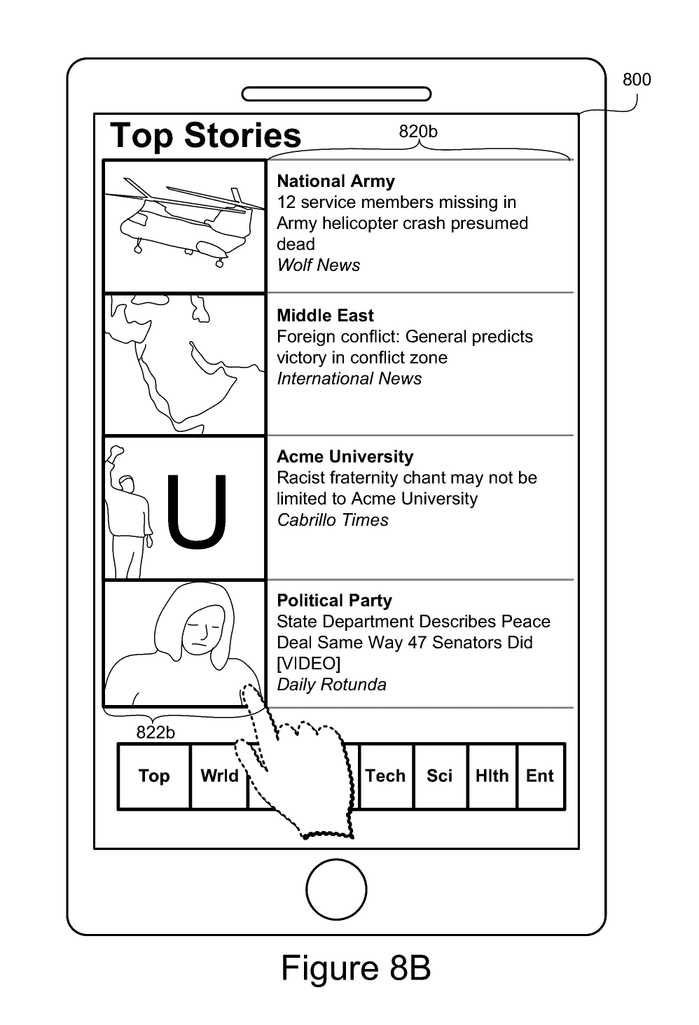

If the interface module 1022 determined 110 that the input received did not includes a display region selection, the method 100 proceeds to block 114. At block 114, the interface module 1022 determines whether the input received at 104 includes a horizontal selection area swipe. A swipe may include any moving or sliding of an indicator across an area of a graphical interface. In particular, a horizontal selection area swipe includes sliding an indicator horizontally across the graphical user interface beginning at the selection area 816. For example, a horizontal selection area swipe and corresponding update of the user interface is shown in FIGS. 8A-8B. In order for the interface module 1022 to differentiate between a high-level interaction region scrub at 106 and a horizontal selection area swipe at block 114 (e.g., when the high-level interaction region 602 is horizontally oriented), the interface module 1022 may determine the location of the scrub vs the location of the swipe. A scrub, as determined at 106, is located (approximately or exactly) over the high level interaction region 602. A swipe, as determined at 114, is located (approximately or exactly) over the display region(s). For example, a swipe may include selecting and dragging a selection area/column 816/822 described elsewhere herein.

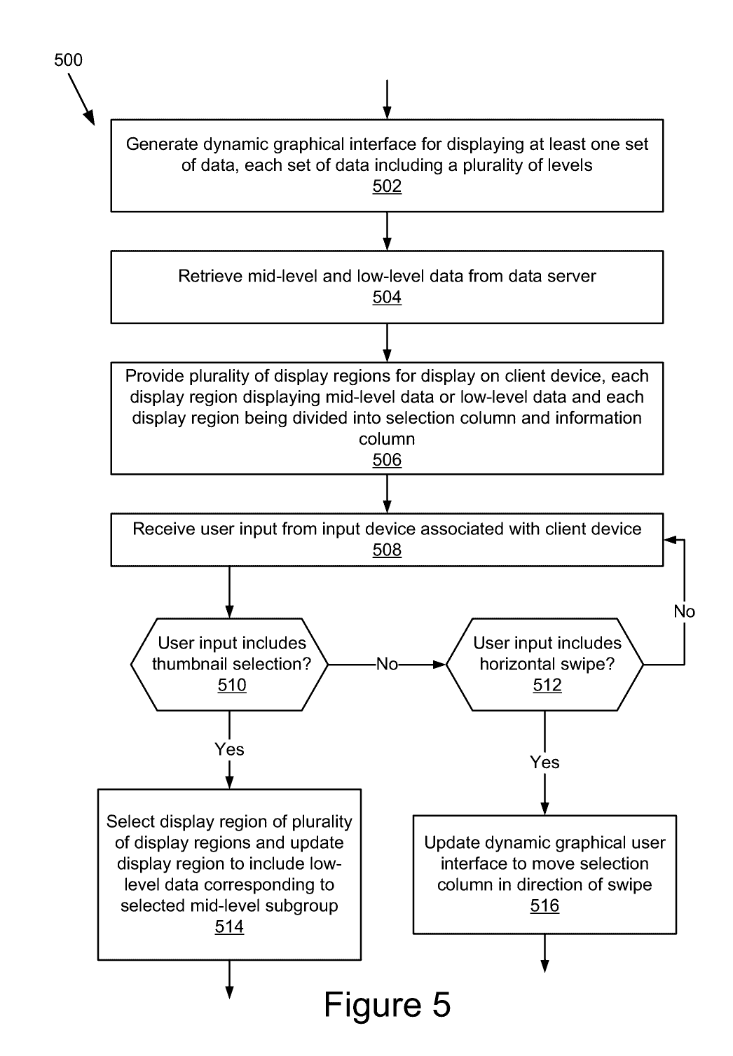

If the interface module 1022 determined 114 that the input received at 104 was a horizontal selection area swipe, the method 100 proceeds to block 116. At block 116, the interface module 1022 updates the display region(s) to toggle from a right handed to a left handed layout (or vice versa) in response to a determination at 114 that the input included a horizontal swipe of a selection area. In some implementations, as discussed above, the display region(s) may include information and selection columns 820 and 822 that can be re-arranged in order to provide a left or right handed layout of the graphical interface. For example, the selection column 822 can be dragged/swiped to toggle the display region(s) from a right (e.g., as in FIG. 8A) to left handed layout (e.g., as in FIG. 8B) to provide easier input access when the graphical interface is on a touchscreen device (e.g., client device 906) and to prevent obstruction of the information areas 814 by a finger interacting with the touchscreen. Updating the display regions 608, 610, 612, and 614 to toggle between a right and left handed layout in response to a horizontal selection area swipe is described in further detail in reference to FIGS. 5, 8A, and 8B. On the other hand, if the interface module 1022 determined 114 that the input received at 104 was not a horizontal selection area swipe, the method 100 loops to step 104.

FIG. 2 is a flow chart of an example method 200 for updating display regions 608, 610, 612, and 614 in response to receiving a high-level interaction region scrub/selection. The method 200 provides further detail for the blocks 106 and 108 shown in FIG. 1. At 202, the interface module 1022 generates a dynamic graphical interface including a defined layout for displaying a plurality of sets of data, the sets of data including a plurality of levels, and at 204 the interface module 1022 provides a high-level interaction region 602 including sub-regions for display on a client device 906, each sub-region corresponding to a high-level group.

An example high-level interaction region 602 is displayed in FIG. 6. As shown, the high-level interaction region 602 may be statically located proximate to the bottom of the graphical interface 600 to provide easy access by a finger (e.g., as illustrated by indicator 630) on a touch screen client device (e.g., as shown in FIGS. 6A-6D). For example, the placement of the high-level interaction region 602 shown in FIG. 6 advantageously allows a user using one hand to scrub/select a high-level group by sliding the thumb along the high-level interaction region 602. Additionally, as shown, the high-level interaction region 602 may include a plurality of sub-regions 604a-604h. For example, the sub-regions may correspond to a category or subject. In the example depicted in FIG. 6, each sub-region relates to a news category (e.g., top stories, world, US, business, technology, science, health, entertainment, etc.). In instances where the sub-regions and high-level interaction region 602 are statically located, a user beneficially doesn't have to look at the high-level interaction region 602 or sub-regions in order to select a sub-region/high-level group. In some implementations, the specific sub-regions 604a-604h displayed in the interface may be customizable or expandable. Additionally, in some instances, the graphical interface may include a high-level group selection indicator 606 that displays which high-level group (e.g., from the sub-regions 604a-604h) is selected. While eight sub-regions 604a-604h are shown, fewer or additional sub-regions may be used without departing from the scope of the techniques described herein. It should be understood that although the high-level interaction region 602, sub-regions 604a-604h, and selection indicator 606 are displayed in a particular configuration in FIG. 6, other implementations are possible and contemplated herein, for example, the high-level interaction region 602 could be vertically oriented along a left or a right side of a graphical user interface or the selection indicator may merely consist of highlighting the selected sub-region.

FIG. 6A illustrates an example initial graphical user interface 600 wherein the interface module 1022 is waiting to receive a user input. For example, a category represented by a sub-region 604a may be initially shown on the graphical user interface 600. FIG. 6B illustrates the example graphical user interface 600 upon receiving an input by an indicator 630, as shown, the sub-region 604a may be highlighted (or otherwise changed) to reflect that it is selected. Similarly, the selection indicator 606 illustrates the category corresponding to the selected sub-region 604a. FIG. 6C illustrates the example graphical user interface 600 wherein a scrubbing input is being received. For example, the indicator 630 is scrubbing across the high-level interaction region 602. In the example illustrated in FIG. 6C, the interface module 1022 may recognize the scrub, but wait for the indicator to pause or slow down over or approximately over a particular sub-region.

FIG. 6D illustrates the example graphical user interface 600 wherein the interface module 1022 has recognized that the scrubbing input selected the sub-region 604b. Sub-region 604d, in the depicted implementation, corresponds to the World News category, which may be displayed in the selection indicator 606. Additionally, it can be seen in FIG. 6D that each of the display regions 608, 610, 612, and 614, as well as their respective elements, have remained statically located in the graphical user interface 600. However, the information displayed within the display regions 608, 610, 612, 614 has been changed to reflect the selected sub-region 604b. In some implementations, the interface module 1022 may recognize the input as selecting sub-region 604b and therefore the World News category and may communicate with the data analysis engine 918 (e.g., via the data handler 1020, communication module 1002, and network 902, as described herein) to retrieve a data set including hierarchical data for the selected high-level group (e.g., category selected at the sub-region 604b).

Returning to FIG. 2, at 206, the data handler 1020 retrieves set(s) of data from the data server 916. For example, the data handler 1020 may retrieve sets of data in response to a certain signal, which may include the opening of a webpage or web-app, execution of an application, or reception of a user input. For example, in some implementations, the interface module 1022 receives user input, in response to which it signals the data handler 1020 to retrieve set(s) of data from the data server 916 (e.g., via the network 902 in FIG. 9).

In some implementations, the data handler 1020 retrieves the sets of data (e.g., the data corresponding to the high, mid, and low levels of each high-level group) for the groups represented by the sub-regions 604a-604h. In some implementations, the data handler 1020 only retrieves the set of data corresponding to the selected high-level group. In some implementations, the data handler 1020 retrieves data (e.g., mid-level data, low-level data, etc.) only as necessary to display the information on the graphical interface. For example, if a user has selected a particular high-level group and mid-level subgroup, the data handler 1020 may retrieve only that data required to display the selected data on the interface (e.g., the data require to display the number of low-level items corresponding to the available display regions for the selected mid-level subgroup).

The data handler 1020 may send the data retrieved from the data server 916 to the interface module 1022 for further processing or, in some instances, it may store the retrieved data in the data store 1012 for access by other components of the data presentation module 908.

At 208, the interface module 1022 provides display regions 608, 610, 612, and 614 having a defined layout for display on a client device 906, each display region being configured to display mid-level data for a mid-level subgroup. For example, the interface module 1022 accesses the datasets 1014 stored in the data store 1012 by the data handler 1020 and generates the interface using the datasets in the display regions 608, 610, 612, and 614. As described elsewhere herein, mid-level data reflects the contents of a mid-level subgroup. For example, each display region displays mid-level data for each mid-level subgroup in a high-level group. A plurality of example display regions 608, 610, 612, and 614 are illustrated in FIGS. 6-8B. In the depicted implementation of FIG. 6A-6D, each display region 608, 610, 612, and 614 is displaying mid-level data for a mid-level group. For instance, news data is displayed in the example interface 600 and each mid-level group corresponds to an event in the “Top Stores” selected high-level group 604a.

The defined layout, as illustrated in FIGS. 6A-8B may include one or more display regions 608, 610, 612, and 614 which may be rectangular regions stacked upon each other as in a column of display regions. In some instances, the display regions 608, 610, 612, and 614 are bounded as shown by the brackets in FIGS. 6A-8B. The display regions 608, 610, 612, and 614 may extend from a left side to a right side of the graphical user interface and may be broken into constituent elements, e.g., an information area 814 and a selection area 816. Additionally, the information area 814 may be further broken into one or more regions for displaying pieces of information, For example, the title 702a, source 704a, subject 706a, category 710a, etc. displayed in FIGS. 7A-7C, may be displayed in particular regions of an information area 814. In some implementations, the defined layout includes a selection indicator 606 located proximate to the top of the graphical user interface (e.g., 600, 700, or 800 as displayed in FIGS. 6A-8B), the high-level interaction region 602 located proximate to the bottom of the graphical user interface, and several (e.g., 4-6) display regions 608, 610, 612, and 614 fill the area in between the selection indicator 606 and the high-level interaction region 602.

Returning to FIG. 2, at 210 the interface module 1022 receives user input including scrubbing across the high-level interaction region 602, the scrubbing reflecting a selection of a sub-region/high-level group and, at 212, in response to receiving the scrubbing input, the interface module 1022 updates the display regions 608, 610, 612, and 614 to include mid-level data corresponding to the selected high-level group, as described in more detail herein.

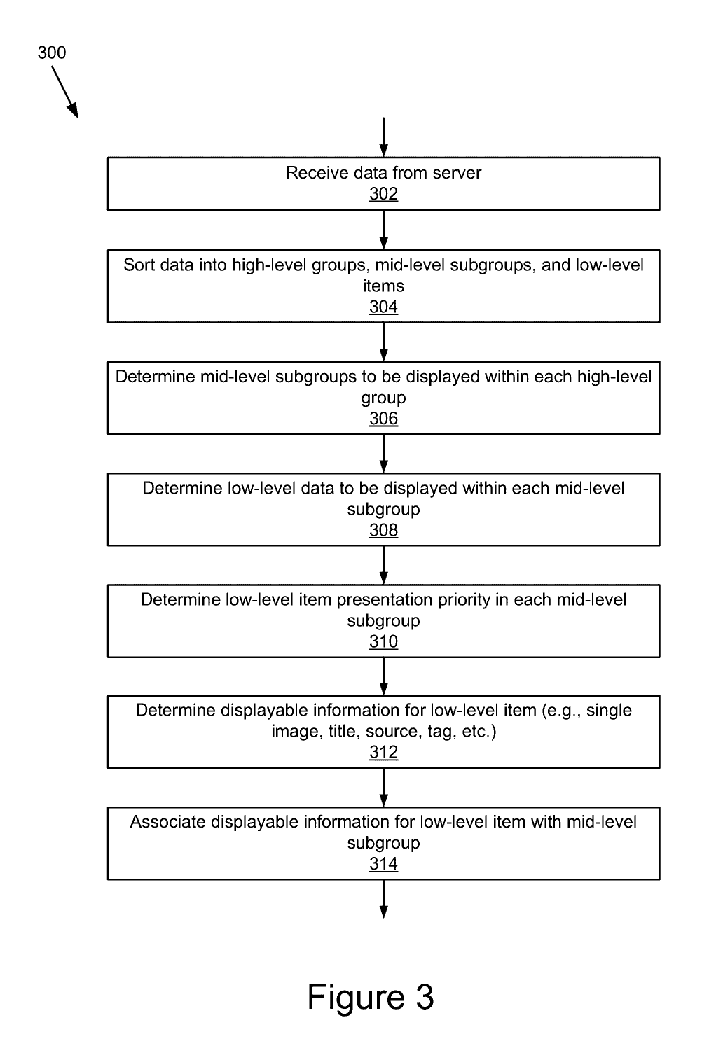

FIG. 3 is a flow chart of an example method 300 for receiving and processing data for presentation and navigation on a client device 906. At 302, the data handler 1020 receives data from the data server 916, as described above in reference to block 206 in FIG. 2. It should be understood that the datasets retrieved by the data handler 1020 may already (e.g., prior to being downloaded by the data handler 1020) be sorted into high, mid, and low levels, ranked according to certain criteria, and/or tagged by the data analysis engine 918 (as shown in FIG. 9). In particular, the datasets should be processed by the data analysis engine 918 prior to being received by the data handler 1020, so that heavy processing is not performed by the data presentation module 908. Accordingly, while some or all of the processing performed by the data analysis engine 918 may be performed by the data presentation module 908, the method 300 is described principally as though the datasets have been processed by the data analysis engine 918 and then retrieved for use by the data presentation module 908. Additionally, it should be understood that additional operations and functionality described in reference to the data presentation module 908 may be performed by the data analysis engine 918.

At 304, the categorization module 1024 may access the dataset(s) retrieved by the data handler 1020 and sort the data into high-level groups, mid-level subgroups, and low-level items. In some implementations, the high, mid, and low level data include tags (e.g., as tagged by the data analysis engine 918 and included in metadata of data items) that dictate ranking, level (high, mid, low, etc.) of data each low-level item, and/or to which hierarchical group or subgroup each item belongs. For example, a low-level item may include tags that dictate that the item belongs in a particular mid-level subgroup and a particular high-level group. The categorization module 1024 may sort these data items into mid-level subgroups and high-level groups according to the tags.

At 306, the ordering module 1026 processes the sorted dataset to determine mid-level subgroups to be displayed within each high-level group (e.g., as received from the categorization module 1024 or in a memory on the client device 906). In some implementations, the datasets retrieved by the data handler 1020 include only the quantity of mid-level subgroups that corresponds to the number of display regions 608, 610, 612, and 614 in the interface. For example, in the example illustrated in FIG. 6, only four display regions 608, 610, 612, and 614 are rendered, so data corresponding to (e.g., tagged as belonging to) a maximum of four mid-level subgroups in each high-level group are retrieved from the data server 916.

Similarly, in some implementations, the datasets retrieved by the data handler 1020 may include only the quantity of low-level items that corresponds to the number of display regions 608, 610, 612, and 614 in the interface. For example, in the example illustrated in FIG. 7, only four display regions 608, 610, 612, and 614 are rendered, so data corresponding to (e.g., tagged as belonging to) a maximum of four low-level items in each mid-level subgroup are retrieved from the data server 916.

At 308, the ordering module 1026 processes the sorted dataset to determine low-level items to be displayed within each mid-level subgroup. In some implementations, the data handler 1020 only retrieves predefined data for each low-level item, which is then displayed as low-level data within each mid-level subgroup, although, in other implementations, it is possible for the data handler 1020 to retrieve a low-level item (e.g., a news article) in its entirety and the ordering module 1026 determines which low-level data to display using textual analysis, metadata tags, etc.

The low-level data displayed (e.g., in the display region(s)) may include specific information for each low-level item. For instance, as illustrated in the example implementation in FIG. 7, the low-level data displayed may include a title 702, a source 704, a classification 706, a subject 710, and/or an image 712, although other implementations are possible, as described in reference to block 312 below. In the example depicted in FIG. 7, the designated priority (as defined in reference to 310 below) article includes a subject 708 rather than a classification 706, although other implementations are possible and contemplated. Additionally, in some implementations, only the designated priority article includes a displayed image (which may be retrieved, for that article, by the data handler 1020), although other implementations are possible, e.g., where each of the low-level data items/articles include an image (if available).

At 310, the ordering module 1026 determines the low-level data presentation priority in each mid-level subgroup. The low-level data presentation priority defines in which order to present the low-level items and, in some implementations, which of those items will be the designated priority item. Low-level data for a designated priority item may be displayed to represent a mid-level subgroup. For example, a designated priority item may be the most popular news article in a cluster of news articles for an event and the low-level data for the designated priority article may be displayed as mid-level data to reflect the contents of an entire mid-level subgroup or cluster of articles. In some instances, the designated priority item may be an item that has been ranked and whose ranking satisfies a threshold. For example, the ranking may be based on a metadata tag on a low-level item (e.g., dictating a popularity of the item) and whether the low-level item includes an associated image (e.g., in the case of a news article, if the news article includes an image).

In some implementations, prior to sending the data sets to the data presentation module 908, the data analysis engine 918 has determined (or may determine in response to a service request by the data presentation module 908) the designated priority item, the display order for the remaining items, and/or a ranking for low-level items and/or mid-level subgroups, and tags the items accordingly for recognition by the ordering module 1026. A designated priority item is any item that corresponds to an item that fits, e.g., has highest priority or ranking within or corresponds most closely to, a defined set of criteria. For example, a low-level item may be ranked based on popularity overall, popularity within a category (e.g., within a mid-level subgroup, within a high-level group, etc.), depth of content, reputation of its source, etc. In another example, a low-level item includes tags (e.g., as determined by the data analysis engine 918) describing a classification of the low-level item. For instance, in the example depicted in FIG. 7C, the classifications (710a, 710c, and 710d) may include “in depth,” “opinion,” and “international,” but may also include a top ranked article, local source, specific sources, trending (e.g., on a social network, in popularity, etc.) items, highly cited, frequently shared, most viewed, etc.

In some implementations, the ordering module 1026 determines the presentation priority by evaluating each item to determine the highest ranked item that has an associated image, which is then displayed as the designated priority item in a given display region. The given display region corresponds to the display region in which mid-level subgroup data was/is displayed for the subgroup to which that particular designated priority item belongs. For example, a designated priority news article is displayed in display region 610 in FIGS. 7A-7C.

In the example illustrated in FIGS. 7A-7C, a user has selected a display region/mid-level subgroup 610 from the list of subgroups displayed in FIG. 7A, upon which, the data presentation module 908 updates all of the other display regions 608, 612, and 614 to reflect the non-designated priority low-level data. In some instances, the non-designated priority items are displayed in order (e.g., according to a ranking as discussed above) in the remaining display regions (e.g., 608, 612, 614). For example, if the designated priority article is ranked third and displayed in display region 610, then the remaining articles ranked first, second, and fourth would be presented within display regions 608, 612, and 614 respectively. Because the displayed data for a selected mid-level subgroup remains unchanged when the display regions are updated with low-level data, the change appears less jarring to the user.

Alternatively or in addition, in some implementations, the order in which the items are displayed within the display regions 608, 610, 612, and 614 is dictated by their classifications (e.g., as described above). For example, in FIG. 7C, display region 608 displays an item with the classification 710a “In Depth,” display region 612 displays an item with the classification 710c “Opinion,” and display region 614 displays an item with the classification 710d “International.” The placement and specific classifications displayed may be predetermined (e.g., according to an administrator setting, available classifications, etc.) for the data presentation module 908 or may be dictated by the available low-level items and classifications provided by the data analysis engine 918. For example, in one implementation, the designated priority low-level item is displayed in one display region and the remainder of the display regions are filled with low-level items having one or more of the classifications mentioned above.

At 312, the ordering module 1026 determines displayable information for the display regions 608, 610, 612, and 614 from the data sets retrieved from the data server 916 based on the display priority, the available data fields in the display regions, and/or the metadata tags, as described above. In some implementations, the displayable information may include a summary, a title 702a-702d, a source 704a-704d, a classification 710a-710d, a subject 706a-706d, an image 708a-708d, and/or any other textual or graphical information that may each be determined for the item (e.g., based on the content of the item/article and/or metadata tags associated with the item/article).

In some implementations, the displayable information may vary for one or more of the low-level items. For example, different information/low-level data may be displayed for the designated priority item than for the non-designated priority items. For instance, in the example implementation illustrated in FIG. 7C, the displayable information for the designated priority article in display region 610 includes a subject 706b, a title 702b, a source 704b, and an image 708b, whereas the displayable information for an item/article other than the designated priority item, e.g., as displayed in 608, may include a classification 710a, a title 712a, and a source 714a, but no image. It should be understood that, although the implementation depicted in FIGS. 7A-7C refers to articles, titles, classifications, etc., other implementations are possible and contemplated by the techniques described herein.

At 314, the ordering module 1026 associates the displayable information for low-level data with the mid-level subgroup. In particular, in some implementations, the ordering module 1026 associates the displayable information for the designated priority item with the mid-level group to which that designated priority item belongs. In particular, the displayed information for each mid-level subgroup may merely be the low-level data for a particular low-level item, e.g., a designated priority item. For example, the information displayed in display region 708b of FIG. 7 is also displayed as mid-level subgroup data in display region 608b of FIG. 6.

FIG. 4 is a flow chart of an example method 400 for updating display regions 608, 610, 612, and 614 with low-level data in response to receiving a display region selection. The method 400 provides further detail for the blocks 110 and 112 shown in FIG. 1. At 402, the interface module 1022 generates a dynamic graphical interface including a defined layout for displaying at least one set of data, each set of data including a plurality of levels. At 404, the data handler 1020 may retrieve mid-level data for one or more high-level groups. At 406, the interface module 1022 provides a plurality of display regions 608, 610, 612, and 614 having a defined layout for display on a client device 906, each display region being configured to display mid-level data for a respective mid-level subgroup. In particular, the display regions 608, 610, 612, and 614 generated by the interface module 1022 at 406 are capable of displaying mid-level subgroup data for a selected high-level group and then being updated to display low-level data for a select mid-level subgroup.

At 408, the interface module 1022 receives user input indicating a selection of a display region from the plurality of display regions 608, 610, 612, and 614. At 410, the data handler 1020 retrieves low-level data for the mid-level subgroup corresponding to the selected display region from the data server 916 in response to receiving a signal from the interface module 1022 based on a received user input. In some implementations, the low-level data is retrieved along with or as the mid-level data for the selected high-level group, and as such, at 410, the low-level data is retrieved by the data handler 1020 from the data store 1012 described in reference to FIG. 10.

At 412, the interface module 1022 updates the plurality of display regions 608, 610, 612, and 614 to include low-level data corresponding to low-level items within the selected mid-level subgroup using the information retrieved by the data handler 1020. In particular, the interface module 1022 may replace the mid-level subgroup data displayed in the display regions 608, 610, 612, and 614 with the displayable information for each low-level item (e.g., as discussed in reference to FIG. 3). In some implementations, each of the display regions 608, 610, 612, and 614 includes selection and display areas (e.g., as shown in FIGS. 8A-8B) that may display low-level data. A display region may include areas in which to load and display a title 702a, source 704a, classification 710a, subject 706a, image 708a, etc., e.g., as shown in FIGS. 7A-7C. For example, a low-level item may include various low-level data that is tagged or organized as being, for example, a title, source, classification, subject, image, etc., which is loaded into the designated areas in one or more display regions, e.g., as described in further detail in reference to FIGS. 6A-8B.

In some instances, the images in the (e.g. in the selection areas 816) display regions may be grayed out as if the mid-level subgroup has been expanded over the top of the high-level group. For example, the illustrated images 708a, 708c, and 708d are grayed out to show that they correspond to unselected mid-level subgroups. In implementations where the images (e.g., 708a, 708c, and 708d) corresponding to non-selected subgroups are grayed out but still visible, a user can easily select a different mid-level subgroup by selecting the grayed out image corresponding to that mid-level subgroup, which would cause the selected mid-level subgroup to be expanded. Alternatively or in addition, the user can select the selected display region again to return to the previous view including the list of mid-level subgroups (e.g., as shown in FIG. 7A).

Thus, FIG. 7A depicts an example graphical user interface 700 in which display regions 608, 610, 612, and 614 each display mid-level data and images corresponding mid-level subgroups in a selected high-level group. For example, in some implementations, the mid-level data displayed for each mid-level subgroup may include a title 702a-702d, a source 704a-704d, a subject 706a-706d, and an image 708a-708d. FIG. 7B depicts the graphical user interface 700, wherein the display region 610 is being selected by an indicator 630.

FIG. 7C depicts the graphical user interface 700, wherein the display region 610 has been selected by the indicator 730. In the depicted implementation, the mid-level data displayed in display region 610 remains the same, but the data displayed in the information areas (e.g., 814) for each of the display regions 608, 612, and 614 has been updated to reflect low-level items within the selected mid-level subgroup. For example, display region 608 has been updated to include data for a low-level item within the selected mid-level subgroup (e.g., an article within an event based article cluster).

In some implementations, once the low-level items are displayed, a user may then select a single low-level item (e.g., by selecting an information area 814) to display additional low-level data for that item. For example, a user may select an information area in a display region to open the article corresponding to that display region. In another example, the user may select multiple low-level items (e.g., articles) to display more information for each of the selected items (e.g., open the articles).

FIG. 5 is a flow chart of an example method 500 for updating the display regions 608, 610, 612, and 614 to toggle between a right and left handed layout in response to a horizontal selection area swipe. The method 500 provides further detail for the blocks 114 and 116 shown in FIG. 1. At 502, the interface module 1022 generates a dynamic graphical interface for displaying at least one set of data, each set of data including a plurality of levels. At 504, the data handler 1020 retrieves mid-level and low-level data from the data server 916.

At 506, the interface module 1022 provides a plurality of display regions 608, 610, 612, and 614 for display on a client device 906, each display region displaying mid-level data or low-level data and each display region being divided into a selection column 822 and an information column 820. As discussed in reference to FIG. 1 and as illustrated in FIG. 8A, the display regions 608, 610, 612, and 614 may each be divided into an information area 814 and a selection area 816. For example, as illustrated in FIG. 8A, the display region 608 is divided into an information area 814a and a selection area 816a. Additionally, in some instances, the information and selection areas may be aligned to form an information column 820 and a selection column 822.

Although, in some implementations, a user may be able to select a mid-level subgroup and/or a low-level item by selecting an information area 814, the selection areas 816a-816d are ideally provided to allow the user to make a selection without an indicator 630 (e.g., a finger or stylus on a touchscreen, a cursor, etc.) being positioned to block the information in the information area 814 during the selection. For example, FIG. 7B illustrates the selection of a display region 610 by an indicator 730. Similarly, as shown in FIG. 8A, in some implementations, one or more images (e.g., thumbnail images) in the selection areas 816 corresponding to the information in the associated information areas 814 may be displayed in or over the selection areas 816a-816d, although the image display functionality may be turned off as a user preference or may not be present in the implementation. For instance, selection area 816a displays an image corresponding to the information in information area 814a. For example, the image displayed in a selection area 816a may be the first image in a news article where the news article is displayed in an information area 814a.

At 508, the interface module 1022 receives user input from an input device associated with the client device 906 and at 510, the interface module 1022 determines whether the user input includes a click or other selection of a display region or selection area. At 514, based on the determination at 510, the interface module 1022 selects a display region of the plurality of display regions 608, 610, 612, and 614 and updates the selected display region to include-low level data corresponding to the selected mid-level sub-group.

At 512, the interface module 1022 determines whether the input received at 508 includes a horizontal swipe. A horizontal swipe may include any moving or sliding of an indicator across an area (e.g., especially a display region) of a graphical interface in a more horizontal than vertical manner. In particular, the interface module 1022 determines whether there is a horizontal swipe starting at a selection column 822, in response to which, the interface module 1022, updates the dynamic graphical user interface to move the selection column 822 in the direction of the swipe at 516. For example, as illustrated in and described in reference to FIGS. 8A-8B, the interface module 1022 moves the selection column 822 from the an area proximate to the right side of a display (e.g., a touchscreen display of a client device 906) to an area proximate to the left side of the display.

In some implementations, the selection and information columns can be re-arranged in order to provide a left or right handed layout of the graphical user interface 800. For example, the selection column 822 can be dragged/swiped to toggle the display region(s) between a right and left handed layout to provide easier input access when the graphical interface is on a touchscreen device as well as to prevent obstruction of the information area/column by a finger interacting with the touchscreen. For example, FIGS. 8A and 8B illustrate the example interface 800 being toggled from a right handed layout in FIG. 8A to a left handed layout in FIG. 8B. In reference to FIG. 8A, the selection column 822a is illustrated as being on the right side of the graphical user interface 800 and the information column 820 is illustrated as being on the left side of the graphical user interface 800, thereby making it a right handed orientation. In FIG. 8A, the indicator 630 is illustrated swiping (e.g., selecting and dragging) the selection column 822a from the right side of the graphical user interface 800 toward the left side of the graphical user interface 800. FIG. 8B illustrates the example graphical user interface 800 after the layout has been toggled to a left handed orientation. For example, the information column 820b is displayed on the right side and the selection column 822b is illustrated on the left side of the graphical user interface 800 for easy access from the left side the graphical user interface 800. For instance, a user using a touch screen client device 906 may use a finger, e.g., the user's thumb, to select a mid-level subgroup and/or low-level item without obstructing the information section/areas in a right handed layout (e.g., as in FIG. 8A) using a right hand or in a left handed layout (e.g., as in FIG. 8B) using a left hand.

FIG. 9 is a high-level block diagram illustrating an example system 900 for efficiently organizing, presenting, and providing interaction with hierarchical data. The illustrated system 900 includes a client device 906 that is accessed by a user 912, a data server 916 having a data analysis engine 918 and a database 920, and a third-party server 924 having a third-party application 926. The components 906, 916, and 924 are connected via the network 902.

The devices 902, 906, 916, and 924 in FIG. 9 are shown by way of example. While FIG. 9 illustrates a single client device 906, third-party server 924, and server 916, the present disclosure applies to any system architecture having any number of client devices 906, third-party servers 924, and servers 916. Furthermore, while only one network 902 is coupled to the client device 906, the data server 916, and the third-party server 924, in practice one or more networks 902 can be connected to these entities.

While the data analysis engine 918 is shown as operational on the data server 916, the database 920 is shown as stored on the data server 916, the third-party application is shown as operational on the third-party server 924, and the data presentation module 908 is shown as operational on the client device 906, it should be understood that all or part of these components and their functionality may be stored on and/or operational on various components of the system 900. For example, in some implementations, all or some of the functionality and/or components assigned to the data presentation module 908 herein, may be operational on the data server 916.

The client device 906 can be any computing device including one or more memory and one or more processors, for example, a laptop computer, a desktop computer, a tablet computer, a mobile telephone, a smart phone device, a smartwatch or other wearable device, a portable game player, a portable music player, a television with one or more processors embedded therein or coupled thereto or any other electronic device capable of accessing a network. In some implementations, the system 900 includes a combination of different types of client devices 906. For example, a combination of a personal computer and a mobile phone. As will be described below, it should be understood that the present technologies can operate on different models other than a client-server architecture. For example, the client device 906 may include the data presentation module 908 and/or the data analysis engine 918 as well as include other services.

Additionally, all or some of the components of the data presentation module 908 are operable, for example, as a web application on or specialized code executable within a browser, which can be a web browser stored on the on the client device 906 and configured for two-way communications with the data server 916. For example, the browser is a software application for retrieving, presenting, and traversing information resources on the web.

The servers 916 and 924 may include one or more computing devices having data processing, storing, and communication capabilities. For example, the servers 916 and 924 may include one or more hardware servers, server arrays, storage devices and/or systems, etc. In some implementations, the servers 916 and 924 may include one or more virtual servers, which operate in a host server environment and access the physical hardware of the host server including, for example, a processor, memory, storage, network interfaces, etc., via an abstraction layer (e.g., a virtual machine manager). In some implementations, the servers 916 and 924 may include a web server (not shown) for processing content requests, e.g., an HTTP server, a REST (representational state transfer) service, or other server type, having structure and/or functionality for satisfying content requests and receiving content from one or more computing devices that are coupled to the network 902.

In the depicted implementation, the data server 916 may include data analysis engine 918 and a database 920. The data server 916 is operable to receive and respond to content requests from the client devices 906 via the network 902. The data analysis engine 918 is operable to aggregate and serve hierarchical data and may store and provide access to hierarchical data in a data store, e.g., the database 920. The data analysis engine 918 is described in more detail in reference to FIG. 10 and elsewhere herein.

The database 920 is an information source for storing and providing access to data. The data stored by the database 920 may be organized and queried using various criteria including any type of data stored by them, e.g., an item identifier, item-tag association, subject, title, source, category, author, popularity, manufacturer, model, position in a hierarchical dataset, and/or other tags and descriptors. The database 920 may include data tables, databases, or other organized collections of data. Examples of the types of data stored by the database may include, but are not limited to any data that can be organized hierarchically, including, but not limited to, news articles, photographs, social network data, product information, media, and so forth.

The database 920 may be included in the data server 916 or in another computing system and/or storage system distinct from but coupled to or accessible by the data server 916. The database 920 can include one or more non-transitory computer-readable mediums for storing the data. In some implementations, the database 920 may store data associated with a database management system (DBMS) operable on the data server 916. For example, the DBMS could include a structured query language (SQL) DBMS, a NoSQL DMBS, various combinations thereof, etc. In some instances, the DBMS may store data in multi-dimensional tables comprised of rows and columns, and manipulate, i.e., insert, query, update and/or delete, rows of data using programmatic operations.

In the depicted implementation, the third-party server 116 hosts services e.g., a third-party application 926, which, in some implementations, may be individual and/or incorporated into the services provided by the data server 916. The third-party server 924 may be operable to receive and respond to content requests from the client devices 906 and/or the data server 916 via the network 902. In some implementations, the third-party application 926 provides data that may be organized in a plurality of levels or groups. For example, the third-party application 926 and associated third-party server 924 may be a news service providing low-level data/items, e.g., news articles photos, products, media, etc., which may be retrieved and processed by the data analysis engine 918 on the data server 916. For example, the third party application 926 may provide news articles or information from one or more sources, e.g., an online newspaper, news website, blog, etc., in response to service requests from client devices (e.g., client device 906) and/or data servers (e.g., data server 916).

The network 902 enables communications between the client device 906, the data server 916, and the third-party server 924. Thus, the network 902 can include links using technologies including, for example, Wi-Fi, Wi-Max, 2G, Universal Mobile Telecommunications System (UMTS), 3G, Ethernet, 802.11, integrated services digital network (ISDN), digital subscriber line (DSL), asynchronous transfer mode (ATM), InfiniBand, PCI Express Advanced Switching, etc. Similarly, the networking protocols used on the network 902 can include the transmission control protocol/Internet protocol (TCP/IP), multi-protocol label switching (MPLS), the User Datagram Protocol (UDP), the hypertext transport protocol (HTTP), the simple mail transfer protocol (SMTP), the file transfer protocol (FTP), lightweight directory access protocol (LDAP), Code Division Multiple Access (CDMA), Wideband Code Division Multiple Access (WCDMA), Global System for Mobile communications (GSM), High-Speed Downlink Packet Access (HSDPA), etc. The data exchanged over the network 902 can be represented using technologies and/or formats including the hypertext markup language (HTML), the extensible markup language (XML), etc. In addition, all or some of links can be encrypted using conventional encryption technologies, for example, the secure sockets layer (SSL), Secure HTTP and/or virtual private networks (VPNs) or Internet Protocol security (IPsec). In some implementations, the entities can use custom and/or dedicated data communications technologies instead of, or in addition to, the ones described above. Depending upon the implementation, the network 902 can also include links to other networks.

In some implementations, the network 902 is a partially public or a wholly public network, for example, the Internet. The network 902 can also be a private network or include one or more distinct or logical private networks (e.g., virtual private networks, Wide Area Networks (“WAN”) and/or Local Area Networks (“LAN”)). Additionally, the communication links to and from the network 902 can be wired or wireless (i.e., terrestrial or satellite-based transceivers). In some implementations, the network 902 is an IP-based wide or metropolitan area network.

The network 902 may have any number of configurations including a star configuration, token ring configuration or other configurations. Furthermore, the network 902 may include a local area network (LAN), a wide area network (WAN) (e.g., the Internet), and/or any other interconnected data path across which multiple devices may communicate. In some implementations, the network 902 may be a peer-to-peer network. The network 902 may also be coupled to or include portions of a telecommunications network for sending data in a variety of different communication protocols. In some implementations, the network 902 includes short-wavelength communication networks or a cellular communications network for sending and receiving data including via short messaging service (SMS), multimedia messaging service (MMS), hypertext transfer protocol (HTTP), direct data connection, wireless application protocol (WAP), electronic messages, etc.

FIG. 10 is a block diagram illustrating an example computing system 1000. The example computing system 1000 may represent a client device 906, third-party server 924, and/or data server 916, depending on the implementation. As depicted, the computing system 1000 may include a communication module 1002, a processor 1004, a memory(ies) 1006, an input device 1008, an output device 1010, and a data storage 1012, which may be communicatively coupled by a communication bus 1016. The computing system 1000 depicted in FIG. 10 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the computing system 1000 may include various operating systems, sensors, additional processors, and other physical configurations.

The communication module 1002 is coupled to the network 902 by signal line 1018. The communication module 1002 is also coupled to the bus 1016. The communication module 1002 includes ports for wired connectivity including but not limited to USB, SD, or CAT-5, etc. The communication module 1002 links the processor 1004 to the network 902 that may in turn be coupled to other processing systems. The communication module 1002 provides other conventional connections to the network 902 using standard network protocols, e.g., TCP/IP, HTTP, HTTPS and SMTP. In some implementations, the communication module 1002 includes a transceiver for sending and receiving signals using Wi-Fi, Bluetooth®, cellular, or other communications protocols for wireless communication.

The processor 1004 may include an arithmetic logic unit, a microprocessor, a general purpose controller or some other processor array to perform computations and provide electronic display signals to a display device. In some implementations, the processor 1004 is a hardware processor. The processor 1004 is coupled to the bus 1016 for communication with the other components. Processor 1004 processes data signals and may include various computing architectures including a complex instruction set computer (CISC) architecture, a reduced instruction set computer (RISC) architecture, or an architecture implementing a combination of instruction sets. Although only a single processor is shown in FIG. 10, multiple processors may be included. It should be understood that other processors, operating systems, sensors, displays and physical configurations are possible.

The memory(ies) 1006 may store and provide access to data to the other components of the computing system 1000. The memory(ies) 1006 may be included in a single computing device or a plurality of computing devices. In some implementations, the memory(ies) 1006 may store instructions and/or data that may be executed by the processor 1004. For example, in some implementations, the memory(ies) 1006 may store one or more of the data presentation module 908, the data analysis engine 918, and/or the third-party application 926, and their respective components, depending on the configuration. The memory(ies) 1006 is also capable of storing other instructions and data, including, for example, an operating system, hardware drivers, other software applications, databases, etc. The memory(ies) 1006 may be coupled to the bus 1016 for communication with the processor(s) 1004 and the other components of computing system 1000.

The memory(ies) 1006 include a non-transitory computer-usable (e.g., readable, writeable, etc.) medium, which can be any non-transitory apparatus or device that can contain, store, communicate, propagate or transport instructions, data, computer programs, software, code, routines, etc., for processing by or in connection with the processor(s) 1004. In some implementations, the memory(ies) 1006 may include one or more of volatile memory and non-volatile memory. For example, the memory(ies) 1006 may include, but is not limited to, one or more of a dynamic random access memory (DRAM) device, a static random access memory (SRAM) device, a discrete memory device (e.g., a PROM, FPROM, ROM), a hard disk drive, an optical disk drive (CD, DVD, Blue-Ray™, etc.). It should be understood that the memory(ies) 1006 may be a single device or may include multiple types of devices and configurations.

The input device 1008 may include any device for inputting information into the computing system 1000. In some implementations, the input device 1008 may include one or more peripheral devices. For example, the input device 1008 may include a keyboard (e.g., a QWERTY keyboard), an indicator or pointing device (e.g., a mouse or touchpad), microphone, an image/video capture device (e.g., camera), etc. In some implementations, the input device 1008 may include a touch-screen display capable of receiving input from one or more fingers or a stylus of the user. For instance, the structure and/or functionality of one or more of the input device 1008 and the output device 1010 may be integrated, and a user of the computing system 1000 may interact with the computing system 1000 by contacting a surface of a display (e.g., an output device 1010) using one or more fingers. Additionally, in this example, the user could interact with an emulated (e.g., virtual or soft) keyboard displayed on a touch-screen output device 1010 by using fingers to contact the display in the keyboard regions.

The output device 1010 may be any device capable of outputting information from the computing system 1000. The output device 1010 may include one or more of a display, a printer, a haptic device, audio reproduction device, etc. In some implementations, the output device 1010 may include a touch-screen display capable of receiving input from one or more fingers of a user 912. For example, the output device 1010 may include a capacitive touch-screen display capable of detecting and interpreting multiple points of contact with the display surface. In some implementations, the computing system 1000 may include a graphics adapter (not shown) for rendering and outputting the images and data for presentation on output device 1010. The graphics adapter (not shown) may be a separate processing device including a separate processor and memory (not shown) or may be integrated with the processor 1004 and memory(ies) 1006.

The data store 1012 is an information source for storing and providing access to data. The data stored by the data store 1012 may be organized and queried using various criteria including any type of data stored by them, e.g., an item identifier, item-tag association, subject, title, source, category, author, popularity, manufacturer, model, position in a hierarchical dataset, and/or other tags and descriptors. The data store 1012 may include data tables, databases, or other organized collections of data. An examples of the types of data stored by the data store 1012 includes, but is not limited to, datasets 1014, etc.

The data store 1012 may be included in the computing system 1000 or in another computing system and/or storage system distinct from but coupled to or accessible by the computing system 1000. The data store 1012 can include one or more non-transitory computer-readable mediums for storing the data. In some implementations, the data store 1012 may be incorporated with the memory(ies) 1006 or may be distinct therefrom. In some implementations, the data store 1012 may store data associated with a database management system (DBMS) operable on the computing system 1000. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations.

The datasets 1014 may include any data which may be organized into a plurality of levels or data trees. The datasets 1014 can be organized (e.g., in the data structure, using tags, etc.) into groups of low-level items (e.g., mid-level subgroups), each low-level item having low-level data and/or metadata. Groups of low-level items (e.g., mid-level subgroups) can be organized into high-level groups. In some implementations, the datasets 1014 may be downloaded and stored to the data store 1012. In some implementations, the data store 1012 may include references to some or all of the datasets stored on a data server 916 or third-party server 924. For instance, some or all of the displayable information relating to an item may include an iframe or object which displays the applicable data. For example, the client device 906 may retrieve and display an image for a low-level item directly from a third-party server 924. Additionally, it should be understood that the datasets 1014 could additionally or alternatively be stored on the database 920 and may exist only temporarily in the memory (e.g., in the data store 1012 or memory 1006) on the client device 906.

The bus 1016 can include a communication bus for transferring data between components of a computing device or between computing devices, a network bus system including the network 902 or portions thereof, a processor mesh, a combination thereof, etc. In some implementations, the data handler 1020, interface module 1022, categorization module 1024, and ordering module 1026 and various other components operating on the computing device 1000 (data analysis engine 918, third-party application 926, operating systems, device drivers, etc.) may cooperate and communicate via a communication mechanism included in or implemented in association with the bus 1016. The bus 1016 may include a software communication mechanism, which can include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

The data presentation module 908 and/or its components may be implemented as entirely hardware or may include computer logic executable by the processor 1004 on a client device 906 to implement routines or methods for efficiently organizing, presenting, and providing interaction with datasets having a plurality of hierarchical levels. In some implementations, the data presentation module 908 may generate and present user interfaces based at least in part on information received from the data analysis engine 918. For example, a user 912 may use the data presentation module 908 to efficiently view/consume and navigate hierarchical data. In some implementations, the data presentation module 908 includes a web browser and/or code operable therein, a customized client-side application (e.g., a dedicated mobile app), a combination of both, etc.

The data handler 1020 handles data requests and responses, and/or provides data to the other components of the data presentation module 908, e.g., the interface module 1022, the categorization module 1024, and/or the ordering module 1026, as applicable. For example, the data handler 1020 may process data requests from the components of the data presentation module 908 to receive/retrieve the applicable data from the data server 916 and/or third-party server 924. The data handler 1020 may receive and respond to the data requests from the other components of the data presentation module 908, for example, via the bus 1016, via the interface module 1022, etc.

The interface module 1022 receives user input from an input device 1008 and processes the user input to determine requested operations. Additionally, the interface module 1022 is coupled to the other components of the computing device 1000 and data presentation module 908 and signals the components of the data presentation module 908 (e.g., 1020, 1024, 1026) to perform their operations. For example, in some implementations, the interface module 1022 may be stored in the memory(ies) 1006 and executed on the processor 1004 to process user input from the input device 1008, request datasets from the data server 916 (e.g., via the data handler 1020 and/or communication module 1002), signal the categorization module and/or ordering module 1026 to process the datasets, and send a graphical interface to the output device 1010 to display the requested information to the user.

The categorization module 1024 may determine to which level and group (e.g., hierarchical group or data tree) each low-level data/item belongs. For example, in response to a signal received from the interface module 1022, the categorization module 1024 accesses the datasets 1014 retrieved by the data handler 1020 (e.g., from the data store 1012) and sorts the data into high-level groups, mid-level subgroups, and low-level data/items (e.g., according to tags in the metadata of the items).

The ordering module 1026 processes the sorted dataset to determine a presentation priority for each mid-level subgroup and high-level group in response to a signal from the interface module 1022 or categorization module 1024. For example, the interface module 1022 signals the ordering module 1026 to process the dataset(s) 1014 to determine a display order for low-level and, in some implementations, mid-level data as described in reference to FIG. 3. The ordering module 1026 may access the data in the data store 1012 and/or receive data directly from one or more components 1020, 1022, or 1024 of the data presentation module 908.

The components 908, 1020, 1022, 1024, and/or 1026 may be software or routines. In some implementations, 908, 1020, 1022, 1024, and/or 1026 may be a set of instructions executable by the processor 1004. In some implementations, 908, 1020, 1022, 1024, and/or 1026 are stored in the memory(ies) 1006 of the system 1000 and are accessible and executable by the processor 1004. The components 908, 1020, 1022, 1024, and/or 1026 may be communicatively coupled by the bus 1016 and/or the processor(s) 1004 to one another and/or the other components 1002, 1004, 1006, 1008, 1010, and/or 1012 of the computing system 1000. In some implementations, the components 1020, 1022, 1024, and/or 1026 may include computer logic executable by the processor(s) 1004 to provide their acts and/or functionality. In any of the foregoing implementations, these components 1020, 1022, 1024, and/or 1026 may be adapted for cooperation and communication with the processor(s) 1004 and other components of the computing system 1000, e.g., the data store 1012 and/or the memory(ies) 1006.

The data analysis engine 918 may be implemented entirely as hardware or may include computer logic executable by the processor 1004 on a computing system 1000 (e.g., data server 916) to implement routines or methods for processing data, for example, to organize it into hierarchical levels/groups, tag items, analyze items, etc., as described above. In some implementations, the data analysis engine 918 is adapted for cooperation and communication with the processor 1004, the memory 1006 and other components of the computing device 1000 (e.g., data server 916) via the bus 1016.

The third-party application 926 may be implemented as entirely hardware or may include computer logic executable the processor 1004 on computing system 1000 (e.g., third-party server 924) to implement routines or methods for serving data/items that may be organized in a hierarchy or data tree, as described above. In some implementations, the third-party application 926 is adapted for cooperation and communication with the processor 1004, the memory 1006 and other components of the computing device 1000 (e.g., third-party server 926) via the bus 1016.

In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some implementations above with reference to user interfaces and particular hardware.

Reference in the specification to “one implementation” or “an implementation” means that a particular feature, structure, or characteristic described in connection with the implementation is included in at least one implementation of the disclosed technologies. The appearances of the phrase “in one implementation” in various places in the specification are not necessarily all referring to the same implementation.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware implementation, an entirely software implementation or an implementation containing both hardware and software elements. In some implementations, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the disclosed technologies were not described with reference to any particular programming language. It will be appreciated that a variety of programming languages may be used to implement the teachings of the technologies as described herein.

The foregoing description of the implementations of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies not be limited by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to implementation in any specific programming language, or for any specific operating system or environment. Accordingly, the disclosure of the present techniques and technologies is intended to be illustrative, but not limiting.

What is claimed is:

1. A method comprising:
generating at the computing device a graphical user interface including a static layout, the static layout including a display region and an interaction region at a first level, the display region configured to display data representing one of a second-level subgroup and a third-level item, and the first-level interaction region having a plurality of sub-regions;
receiving a user input;
determining whether the received user input is a selection of one of the plurality of sub-regions of the first-level interaction region;
in response to the determination that the received user input is the selection of one of the plurality of sub-regions, updating the display region to include the second-level subgroup corresponding to the selection of the one of the plurality of sub-regions;
determining whether the received user input is a selection of the display region; and
in response to the determination that the user input is the selection of the display region, updating the display region to include the third-level item corresponding to the second-level subgroup.

2. The method of claim 1, further comprising retrieving a set of data from a data server, the set of data including a first-level group, a second-level subgroup, and third-level items, the third-level items being articles, the second level-subgroup being a cluster of articles related to a common event, and the first-level group being a group of clusters of articles related to a common category.

3. The method of claim 1, wherein determining whether the received user input is selection of one of the plurality of sub-region includes determining whether the user input includes a scrubbing input across the first-level interaction region.

4. The method of claim 21, wherein the display region includes an information area and a selection area, the information area displaying textual information and the selection area displaying an image corresponding to the textual information.

5. The method of claim 4, wherein the selection area is located proximate to a vertical side of the graphical user interface.

6. The method of claim 4, wherein the graphical user interface includes a plurality of display regions and wherein updating the display region to include the third-level item includes updating each of the plurality of display regions with different data.

7. The method of claim 1, further comprising:
determining a ranking for the third-level item within the second-level subgroup based on a metadata tag associated with the third-level item;
determining whether there is an image associated with the third-level item; and
selecting the third-level item for display in the graphic user interface if a rank of the third-level item satisfies a threshold.

8. The method of claim 1, wherein the display region includes a selection area located proximate to a first vertical edge of the graphical user interface and an information area, and wherein the method further comprises determining whether the user input included a horizontal swipe beginning at the selection area and ending at the information area and in response to a horizontal swipe updating the display region to move the selection area to be located proximate to a second vertical edge of the graphical user interface.

9. A system comprising:
a processor; and
a memory storing instructions that, when executed by the processor, cause the system to:
generate a graphical user interface including a static layout, the static layout including a display region and an interaction region for a first level, the display region configured to display data representing one of a second-level subgroup and a third-level item, and the first-level interaction region having a plurality of sub-regions;
receive a user input;
determine whether the received user input is a selection of one of the plurality of sub-regions of the first-level interaction region;
in response to the determination that the received user input is the selection of one of the plurality of sub-regions, update the display region to include the second-level subgroup corresponding to the selection of the one of the plurality of sub-regions;
determine whether the received user input is a selection of the display region; and
in response to the determination that the user input is the selection of the display region, update the display region to include the third-level item corresponding to the second-level subgroup.

10. The system of claim 9, wherein the memory also stores instructions that, when executed by the processor, cause the system to retrieve a set of data from a data server, the set of data including a first-level group, a second-level subgroup, and third-level items, the third-level items being articles, the second level-subgroup being a cluster of articles related to a common event, and the first-level group being a group of clusters of articles related to a common category.

11. The system of claim 9, wherein the memory also stores instructions that, when executed by the processor, cause the system to determine whether the user input includes a scrubbing input across the first-level interaction region.

12. The system of claim 9, wherein the display region includes an information area and a selection area, the information area displaying textual information and the selection area displaying an image corresponding to the textual information.

13. The system of claim 12, wherein the selection area is located proximate to a vertical side of the graphical user interface.

14. The system of claim 9, wherein the graphical user interface includes a plurality of display regions and wherein the memory also stores instructions that, when executed by the processor, cause the system to update each of the plurality of display regions with different data.

15. The system of claim 9, wherein the memory also stores instructions that, when executed by the processor, cause the system to:
determine a ranking for the third-level item within the second-level subgroup based on a metadata tag associated with the third-level item;
determine whether there is an image associated with the third-level item; and
select the third-level item for display in the graphic user interface if a rank of the third-level item satisfies a threshold.

16. The system of claim 9, wherein the display region includes a selection area located proximate to a first vertical edge of the graphical user interface and an information area, and wherein the memory also stores instructions that, when executed by the processor, cause the system to determine whether the user input included a horizontal swipe beginning at the selection area and ending at the information area and in response to a horizontal swipe update the display region to move the selection area to be located proximate to a second vertical edge of the graphical user interface.

17. A computer program product comprising a non-transitory computer usable medium including a computer readable program, wherein the computer readable program when executed on a computer causes the computer to:
generate a graphical user interface including a static layout, the static layout including a display region and an interaction region for a first level, the display region configured to display data representing one of a second-level subgroup and a third-level item, and the first-level interaction region having a plurality of sub-regions;
receive a user input;
determine whether the received user input is a selection of one of the plurality of sub-regions of the first-level interaction region;
in response to the determination that the received user input is the selection of one of the plurality of sub-regions, update the display region to include the second-level subgroup corresponding to the selection of the one of the plurality of sub-regions; and
determine whether the received user input is a selection of the display region; and
in response to the determination that the user input is the selection of the display region, update the display region to include the third-level item corresponding to the second-level subgroup.

18. The computer program product of claim 17, wherein the computer readable program when executed on the computer also causes the computer to retrieve a set of data from a data server, the set of data including a first-level group, a second-level subgroup, and third-level items, the third-level items being articles, the second level-subgroup being a cluster of articles related to a common event, and the first-level group being a group of clusters of articles related to a common category.

19. The non-transitory computer readable medium of claim 1717, wherein the computer readable program when executed on the computer also causes the computer to determine whether the user input includes a scrubbing input across the first-level interaction region.

20. The non-transitory computer readable medium of claim 1717, wherein the display region includes an information area and a selection area, the information area displaying textual information and the selection area displaying an image corresponding to the textual information.

21. The non-transitory computer readable medium of claim 20, wherein the selection area is located proximate to a vertical side of the graphical user interface.

22. The non-transitory computer readable medium of claim 2017, wherein the graphical user interface includes a plurality of display regions and wherein the computer readable program when executed on the computer also causes the computer to update each of the plurality of display regions with different data.

23. The non-transitory computer readable medium of claim 17, wherein the computer readable program when executed on the computer also causes the computer to:
determine a ranking for the third-level item within the second-level subgroup based on a metadata tag associated with the third-level item;
determine whether there is an image associated with the third-level item; and
select the third-level item for display in the graphic user interface if a rank of the third-level item satisfies a threshold.

24. The non-transitory computer readable medium of claim 17, wherein the display region includes a selection area located proximate to a first vertical edge of the graphical user interface and an information area, and wherein the computer readable program when executed on the computer also causes the computer to determine whether the user input included a horizontal swipe beginning at the selection area and ending at the information area and in response to a horizontal swipe update the display region to move the selection area to be located proximate to a second vertical edge of the graphical user interface.
